(19) United States
(12) Patent Application Publication
(10) Pub. No.: US 2026/0304556 A1
(43) Pub. Date: Oct. 1, 2026

(54) MULTIPLE SIGNAL/CHANNEL BLOCK STRUCTURES

(71) Applicant: Samsung Electronics Co., Ltd., Suwon-si (KR)

(72) Inventor: Hongbo Si, Allen, TX (US)

(21) Appl. No.: 19/562,610

(22) Filed: Mar. 10, 2026

Related U.S. Application Data
(60) Provisional application No. 63/778,886, filed on Mar. 27, 2025.
(60) Provisional application No. 63/824,603, filed on Jun. 16, 2025.
(60) Provisional application No. 63/867,955, filed on Aug. 21, 2025.
(60) Provisional application No. 63/931,027, filed on Dec. 4, 2025.

(51) Int. Cl. H04W 76/40; H04L 5/00; H04W 56/00

(52) U.S. Cl. CPC H04W 76/40; H04L 5/0007; H04W 56/001

(57) ABSTRACT

Apparatuses and methods multiple signal/channel block structures. A method performed by a user equipment (UE) in a wireless communication system includes determining multiple structures for a synchronization signals and physical broadcast channel (SS/PBCH) block. A first structure and a second structure from the multiple structures differ in at least one of components included in the first structure and the second structure and multiplexing patterns of the components in the first structure and the second structure. The method further includes receiving the SS/PBCH block based on the first structure or the second structure.

### CROSS-REFERENCE TO RELATED AND CLAIM OF PRIORITY

The present application claims priority under 35 U.S.C. § 119(e) to U.S. Provisional Patent Application No. 63/778,886 filed on Mar. 27, 2025; U.S. Provisional Patent Application No. 63/824,603 filed on Jun. 16, 2025; U.S. Provisional Patent Application No. 63/867,955 filed on Aug. 21, 2025; and U.S. Provisional Patent Application No. 63/931,027 filed on Dec. 4, 2025, which are hereby incorporated by reference in their entirety.

### TECHNICAL FIELD

The present disclosure relates generally to wireless communication systems and, more specifically, the present disclosure is related to a method and apparatus of multiple signal/channel block structures.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus of multiple signal/channel block structures.

In one embodiment, a user equipment (UE) is provided. The UE includes a processor configured to determine multiple structures for a synchronization signals and physical broadcast channel (SS/PBCH) block. A first structure and a second structure from the multiple structures differ in at least one of components included in the first structure and the second structure and multiplexing patterns of the components in the first structure and the second structure. The UE further includes a transceiver operably coupled to the processor. The transceiver is configured to receive the SS/PBCH block based on the first structure or the second structure.

In another embodiment, a base station (BS) is provided. The BS includes a processor configured to determine multiple structures for a SS/PBCH block. A first structure and a second structure from the multiple structures differ in at least one of components included in the first structure and the second structure and multiplexing patterns of the components in the first structure and the second structure. The BS further includes a transceiver operably coupled to the processor. The transceiver is configured to transmit the SS/PBCH block based on the first structure or the second structure.

In yet another embodiment, a method performed by a user equipment is provided. The method includes determining multiple structures for a SS/PBCH block. A first structure and a second structure from the multiple structures differ in at least one of components included in the first structure and the second structure and multiplexing patterns of the components in the first structure and the second structure. The method further includes receiving the SS/PBCH block based on the first structure or the second structure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example SS/PBCH block composition according to new radio (NR) standards;

FIG. 6 illustrates an example of a first and second SS/PBCH block with a common sub-block according to embodiments of the present disclosure;

FIGS. 7 and 8 illustrate examples of common sub-block sets according to embodiments of the present disclosure;

FIGS. 9-11C illustrate examples of a first and second SS/PBCH block structure with a common sub-block according to embodiments of the present disclosure;

FIG. 12 illustrates an example method performed by a UE in a wireless communication system according to embodiments of the present disclosure;

FIGS. 13A and 13B illustrate examples of SS/PBCH block structures according to embodiments of the present disclosure;

FIGS. 14A and 14B illustrate alternative examples of SS/PBCH block structures according to embodiments of the present disclosure;

FIGS. 15-17 illustrate alternative examples of SS/PBCH block structures according to embodiments of the present disclosure;

FIGS. 18-22 illustrate alternative examples of SS/PBCH block structures according to embodiments of the present disclosure;

FIGS. 23-27 illustrate alternative examples of SS/PBCH block structures according to embodiments of the present disclosure;

FIG. 28 illustrates alternative examples of SS/PBCH block structures according to embodiments of the present disclosure;

FIG. 29 illustrates alternative examples of SS/PBCH block structures according to embodiments of the present disclosure; and

FIG. 30 illustrates an example method performed by a UE in a wireless communication system according to embodiments of the present disclosure.

### DETAILED DESCRIPTION

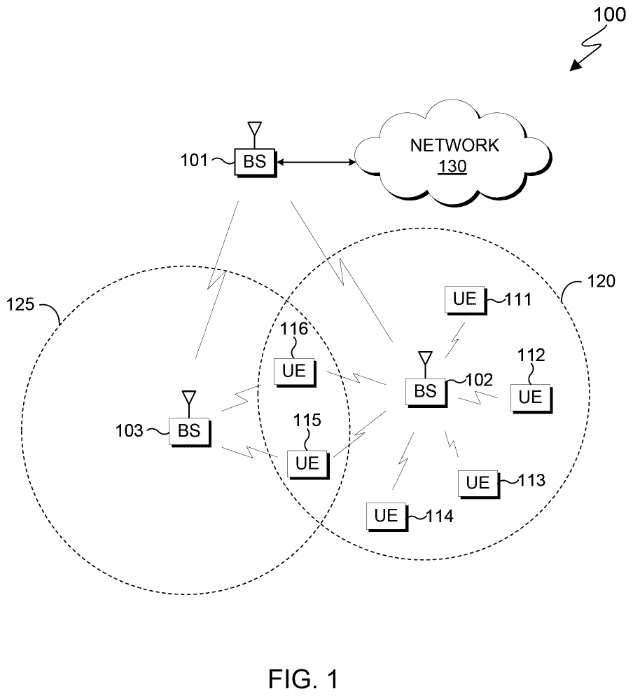

FIGS. 1-30 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.1.0, “NR; Physical channels and modulation” (herein, “REF 1”); 3GPP TS 38.212 v18.1.0, “NR; Multiplexing and channel coding” (herein, “REF 2”); 3GPP TS 38.213 v18.1.0, “NR; Physical layer procedures for control” (herein, “REF 3”); 3GPP TS 38.214 v18.1.0, “NR; Physical layer procedures for data” (herein, “REF 4”); and 3GPP TS 38.331 v18.1.0, “NR; Radio Resource Control (RRC) protocol specification” (herein, “REF 5”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for utilizing multiple signal/channel block structures. In certain embodiments, one or more of the BSs 101-103 include circuitry, programing, or a combination thereof to enable multiple signal/channel block structures.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

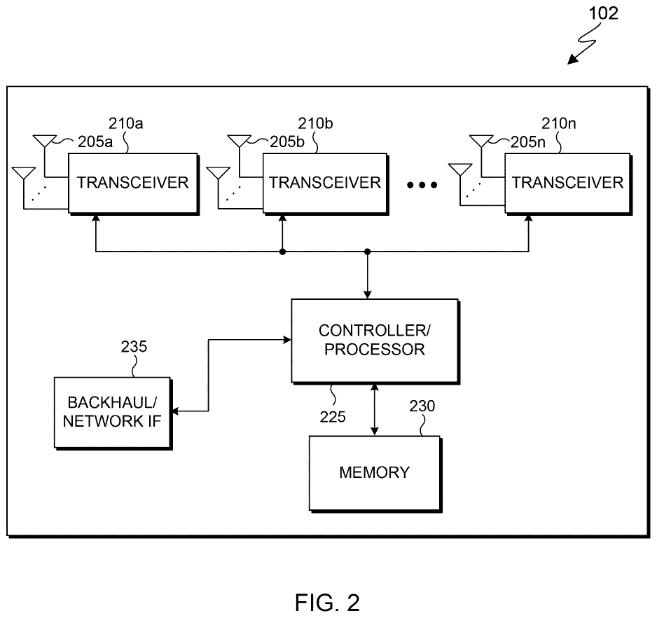

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling of multiple signal/channel block structures. Any of a wide variety of other functions could be supported in the BS 102 by the controller/processor 225.

The controller/processor 225 is also capable of executing programs and other processes resident in the memory 230, such as processes to enable multiple signal/channel block structures. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

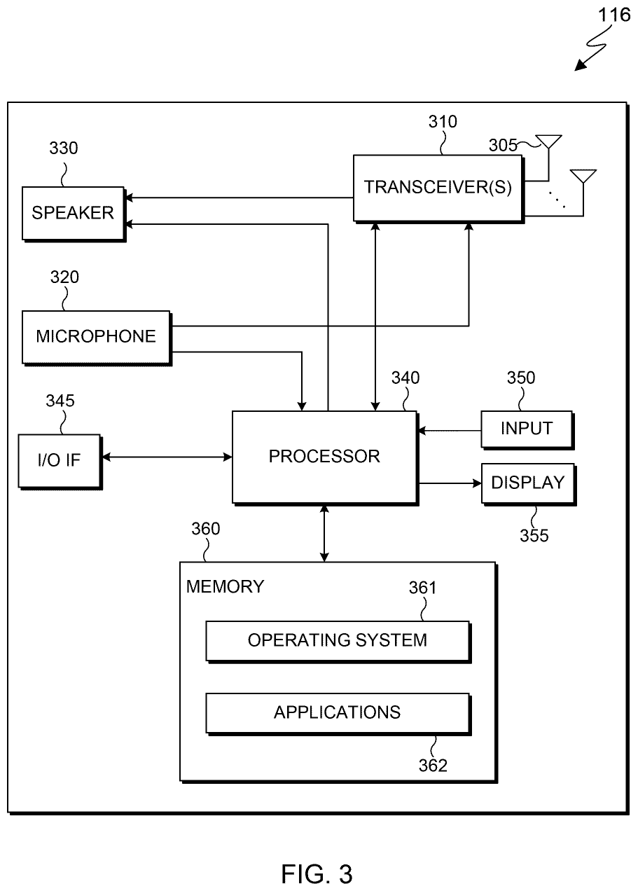

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing multiple signal/channel block structures as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

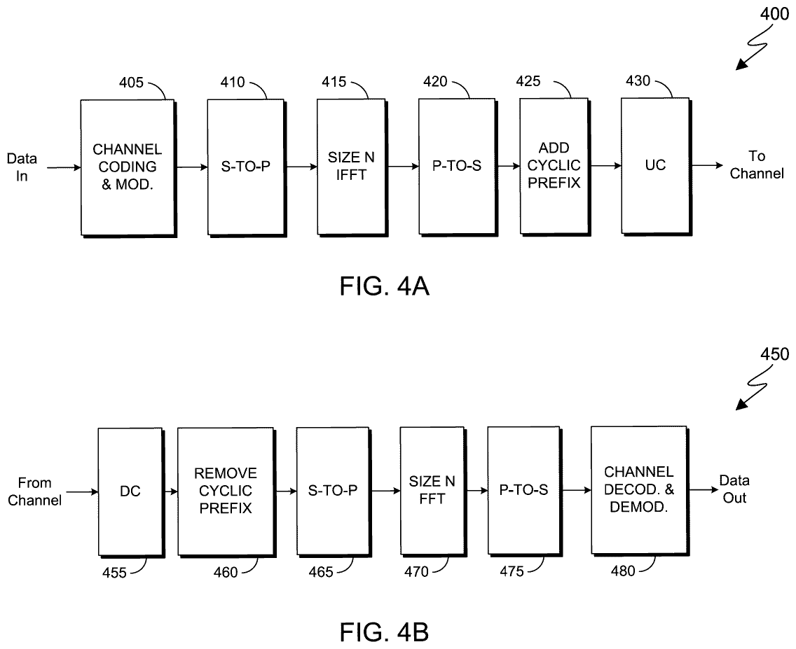

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting multiple signal/channel block structures as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In NR, a cell can be associated with a synchronization signals and/or physical broadcast channel (SS/PBCH) block (SSB), wherein the SSB can be used at least for synchronization and/or measurement. A common SSB structure is applied for all cells, with a potential scaling with the subcarrier spacing (SCS) of the SSB.

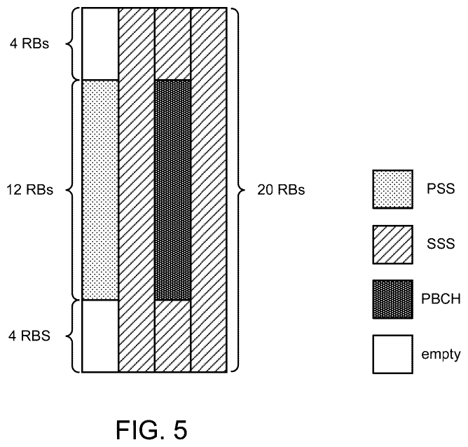

FIG. 5 illustrates an example SS/PBCH block composition according to NR standards. For example, this SS/PBCH block composition can be implemented by BS 102 of FIG. 1. This example is for illustration only and other embodiments can be used without departing from the scope of the present disclosure.

As illustrated in FIG. 5, in NR, each SS/PBCH block compromises four consecutive OFDM symbols, wherein the center 12 resource blocks (RBs) of the first symbol are mapped for primary synchronization signal (PSS), the second and fourth symbols are mapped for PBCH, and the third symbol is mapped for both secondary synchronization signal (SSS) and PBCH. The same SS/PBCH composition is applied to all supported carrier frequency ranges in NR, which spans from 0.41 GHz to 7.125 GHz as Frequency Range 1 (FR1), and spans from 24.25 to 52.6 GHz as Frequency Range 2 (FR2). In every RB mapped for PBCH, 3 out of the 12 resource elements (REs) are mapped for the demodulation reference signal (DM-RS) of PBCH, wherein the 3 REs are uniformly distributed in the RB and the starting location of the first RE is based on cell identity (ID).

For a new generation of wireless communication, the signal and/or channel block (e.g., SSB) can be configured with a different structure for multiple purposes and use cases. This disclosure focuses on the design of multiple structures of the signal and/or channel block (e.g., SSB), and in particular, on the relationship among the multiple structures. Furthermore, to save the energy of a BS, the one shot detection performance for SS/PBCH block can be enhanced, and the time and frequency domain structure for SS/PBCH block can be enhanced accordingly.

In the present disclosure, multiple block structures and their common sub-block (including a multiplexing pattern within the multiple block structures) are provided. The examples of the present disclosure focus on two block structures, and it can be generalized to more than two blocks structures by using multiple examples.

In one embodiment, at least two block structures can be supported, wherein a first block structure and a second block structure, within the at least two block structures, can be different at least in one of the following aspects: 1) frequency domain resources (e.g., a number of subcarriers or a number of resource blocks); or 2) time domain resources (e.g., a number of slot or a number of OFDM symbols); or 3) components in the block (e.g., signal or channel included in the block and the manner or pattern the signal or channel multiplexed in the block, wherein the multiplexing manner or pattern refers a time and/or frequency domain resource mapping of the signal or channel and/or the time and/or frequency domain offset between the signal or channel).

For one further implementation, the components in the block (e.g., the block can refer to synchronization signal and/or physical broadcast channel (SS/PBCH) block, or SSB) can include at least one of the following example:
For a first example, a primary synchronization signal (PSS).
For a second example, a secondary synchronization signal (SSS).
For a third example, a tertiary synchronization signal (TSS), which could be also referred to as additional synchronization signal, or on-demand synchronization signal.
For a fourth example, a demodulation reference signal (DM-RS) of a physical broadcast channel (PBCH).
For a fifth example, a physical broadcast channel (PBCH).
For a sixth example, an additional physical broadcast channel (A-PBCH), which could be also referred to as on-demand PBCH, or system information block 0(SIB 0 ).

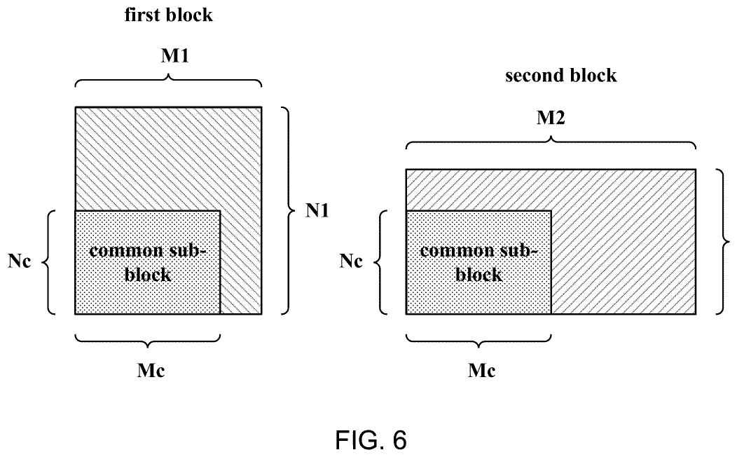

FIG. 6 illustrates an example of a first and second SS/PBCH block with a common sub-block according to embodiments of the present disclosure. For example, the SS/PBCH blocks can be implemented by BS 102 of FIG. 1 This example is for illustration only and other embodiments can be used without departing from the scope of the present disclosure.

For another further implementation, as illustrated in FIG. 6, the first block and the second block can share a same set of time and frequency domain resources with the same components and/or the associated multiplexing pattern inside (e.g., denoted as a common sub-block). The first block has N1 subcarriers or RBs in the frequency domain and M1 slots or OFDM symbols in the time domain. The second block has N2 subcarriers or RBs in the frequency domain and M2 slots or OFDM symbols in the time domain. The common sub-block, included in both the first and second blocks, has Nc subcarriers or RBs in the frequency domain and Mc slots or OFDM symbols in the time domain, wherein Nc≤N1, Nc≤N2, Mc≤M1, Mc≤M2.

For yet another further implementation, the common sub-block can have the same resources in time domain (e.g., the number of slots or OFDM symbols) as the first block, e.g., Mc=M1 (or the second bock, e.g., Mc=M2). For one particular instance, Mc=M1=M2, which implies the difference between the first and the second blocks is frequency domain resources and/or the frequency location of the common sub-block within the first and the second block.

For yet another further implementation, the common sub-block can have the same resources in frequency domain (e.g., the number of subcarriers or RBs) as the first block, e.g., Nc=N1 (or the second bock, e.g., Nc=N2). For one particular instance, Nc=N1=N2, which implies the difference between the first and the second blocks is time domain resources and/or the time location of the common sub-block within the first and the second block.

For yet another further implementation, the common sub-block can have the same resources in time domain (e.g., the number of slots or OFDM symbols) and in frequency domain (e.g., the number of subcarriers or RBs) as the first block, e.g., Mc=M1 and Nc=N1 (or the second bock, e.g., Mc=M2 and Nc=N2). For this case, the first block and the second block have a nesting structure of each other.

In the present disclosure, example multiple block structures are provided.

In one embodiment, at least one of the examples of the first block, the second block, and/or their common sub-block can be supported.

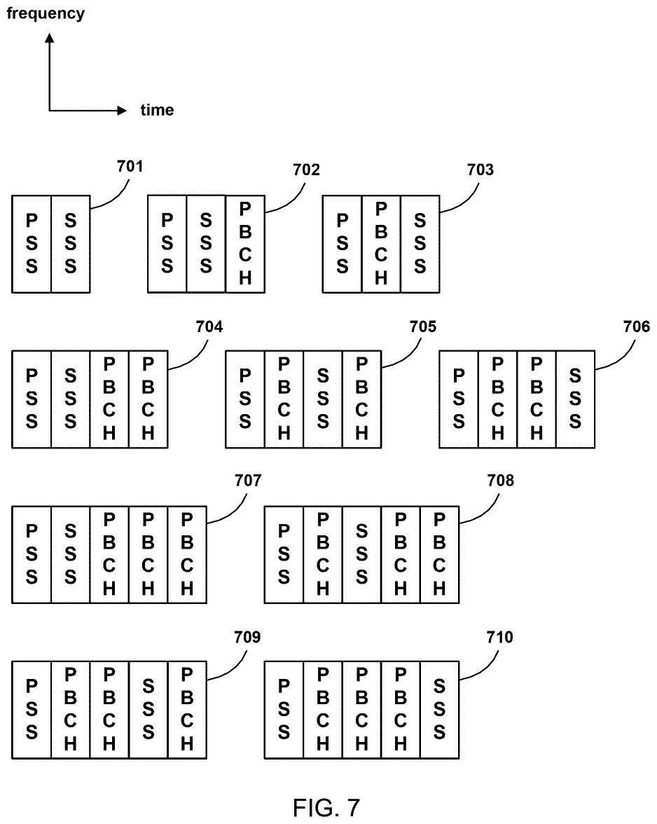

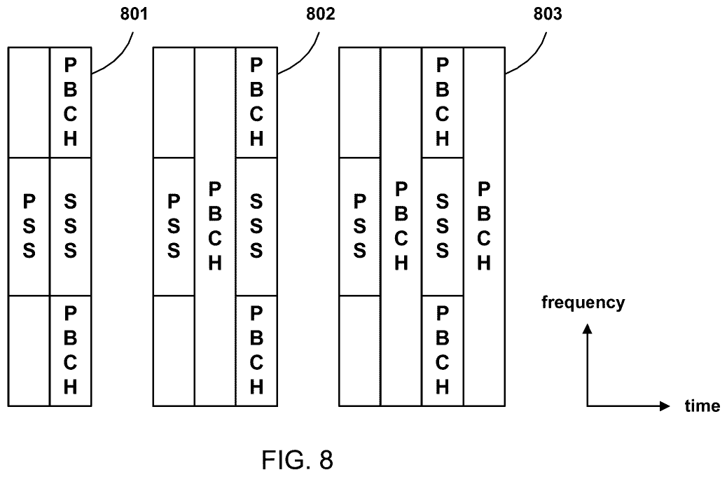

FIGS. 7 and 8 illustrate examples of common sub-block sets according to embodiments of the present disclosure. For example, the common sub-blocks of each set can be implemented by BS 102 of FIG. 1. These examples are for illustration only and other embodiments can be used without departing from the scope of the present disclosure.

As illustrated in FIG. 7, a first set of example common sub-blocks are provided, wherein the unit of a box in the time domain is an OFDM symbol, and the bandwidth in the frequency domain can be 12 RBs or 18 RBs or 20 RBs or 22 RBs or 24 RBs (e.g., the bandwidth of PSS and/or SSS is 12 RBs (or a number of subcarriers within the 12 RBs, wherein the number equals to the sequence length, such as 127 or 141 or 143)). As illustrated in FIG. 8, a second set of example common sub-blocks are provided, wherein the unit of a box in the time domain is an OFDM symbol, and the bandwidth in the frequency domain can be 18 RBs or 20 RBs or 22 RBs or 24 RBs, wherein, e.g., the bandwidth of PSS and/or SSS is 12 RBs (or a number of subcarriers within the 12 RBs, wherein the number equals to the sequence length, such as 127 or 141 or 143).

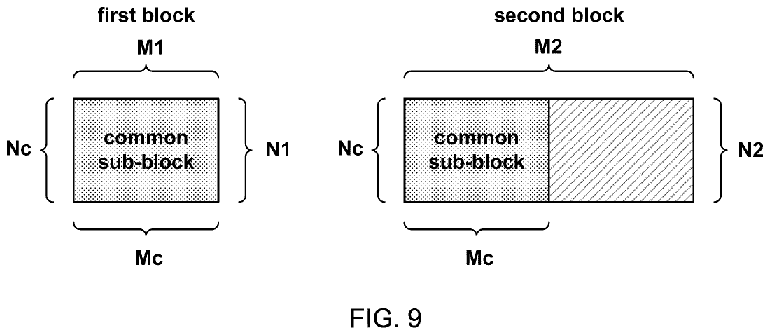

FIGS. 9-11C illustrate examples of a first and second SS/PBCH block with a common sub-block according to embodiments of the present disclosure. For example, the SS/PBCH blocks can be implemented by BS 102 of FIG. 1. These examples are for illustration only and other embodiments can be used without departing from the scope of the present disclosure.

In one example, as illustrated in FIG. 9, Nc=N1=N2, and/or Mc=M1≤M2. For this example, the second block structure can be determined as with the same frequency domain resources (e.g., a number of subcarriers or RBs) as the first block structure, and adding more time domain resources (e.g., a number of slots or OFDM symbols), wherein the more time domain resources for the second block structure can be added before and/or after and/or both before and after the first block structure (e.g., FIG. 9 illustrates an example of adding more time domain resources after the first block structure).
For one sub-example, the first block structure (which is also the common sub-block) has 2 OFDM symbols (e.g., according to 701 in FIG. 7, or 801 in FIG. 8), and/or the second block structure has 4 OFDM symbols (e.g., adding another 2 OFDM symbols mapped for PBCH or A-PBCH before and/or after the first block structure).
For another sub-example, the first block structure (which is also the common sub-block) has 3 OFDM symbols (e.g., according to 702 or 703 in FIG. 7, or 802 in FIG. 8), and/or the second block structure has 4 or 5 OFDM symbols (e.g., adding another 1 or 2 OFDM symbols, respectively, mapped for PBCH or A-PBCH before and/or after the first block structure).
For yet another sub-example, the first block structure (which is also the common sub-block) has 4 OFDM symbols (e.g., according to 704 or 705 or 706 in FIG. 7, or 803 in FIG. 8), and/or the second block structure has 5 or 6 or 7 OFDM symbols (e.g., adding another 1 or 2 or 3 OFDM symbols, respectively, mapped for PBCH or A-PBCH before and/or after the first block structure).
For yet another sub-example, the first block structure (which is also the common sub-block) has 5 OFDM symbols (e.g., according to 707 or 708 or 709 or 710 in FIG. 7), and/or the second block structure has 6 or 7 OFDM symbols (e.g., adding another 1 or 2 OFDM symbols, respectively, mapped for PBCH or A-PBCH before and/or after the first block structure).

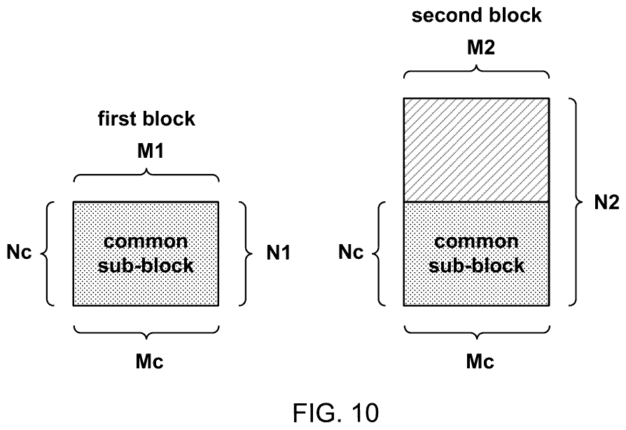

In another example, as illustrated in FIG. 10, Nc=N1≤N2, and/or Mc=M1=M2. For this example, the second block structure can be determined as with the same time domain resources (e.g., a number of slot or OFDM symbols) as the first block structure, and adding more frequency domain resources (e.g., a number of subcarriers or RBs), wherein the more frequency domain resources for the second block structure can be added to lower frequency and/or higher frequency and/or both lower and higher frequency (e.g., with the same number of frequency resources) to the first block structure (e.g., FIG. 10 illustrates an example of adding more frequency domain resources to the higher frequency to the first block structure).
For one sub-example, the first block structure (which is also the common sub-block) has 2 OFDM symbols (e.g., according to 701 in FIG. 7, or 801 in FIG. 8), and/or the second block structure has additional frequency resources in these OFDM symbols (e.g., adding additional subcarriers or RBs mapped for PBCH or A-PBCH FDMed with the first block structure).
For another sub-example, the first block structure (which is also the common sub-block) has 3 OFDM symbols (e.g., according to 702 or 703 in FIG. 7, or 802 in FIG. 8), and/or the second block structure has additional frequency resources in these OFDM symbols (e.g., adding additional subcarriers or RBs mapped for PBCH or A-PBCH FDMed with the first block structure).
For yet another sub-example, the first block structure (which is also the common sub-block) has 4 OFDM symbols (e.g., according to 704 or 705 or 706 in FIG. 7, or 803 in FIG. 8), and/or the second block structure has additional frequency resources in these OFDM symbols (e.g., adding additional subcarriers or RBs mapped for PBCH or A-PBCH FDMed with the first block structure).
For yet another sub-example, the first block structure (which is also the common sub-block) has 5 OFDM symbols (e.g., according to 707 or 708 or 709 or 710 in FIG. 7), and/or the second block structure has additional frequency resources in these OFDM symbols (e.g., adding additional subcarriers or RBs mapped for PBCH or A-PBCH FDMed with the first block structure).

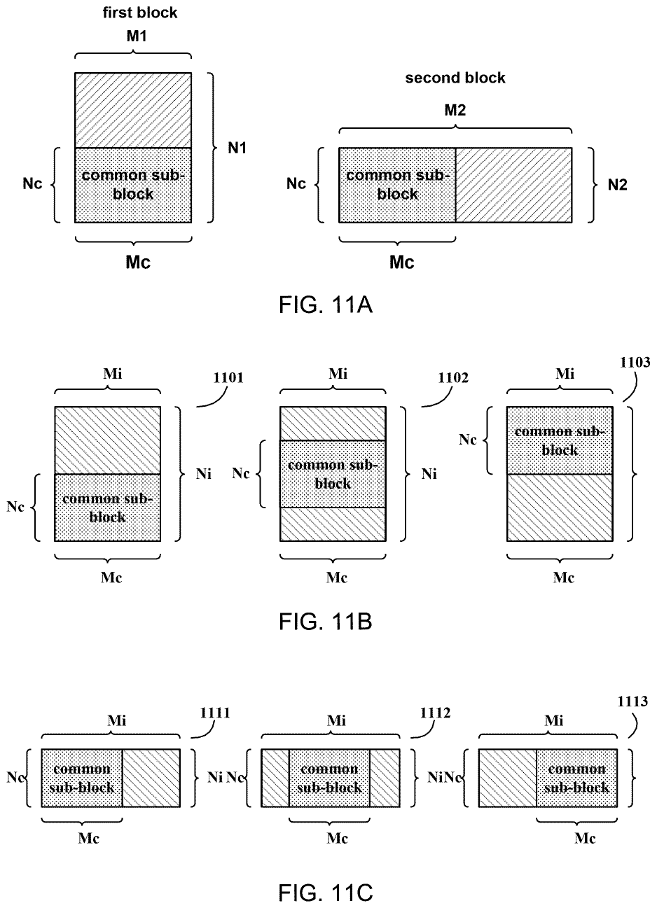

In yet another example, as illustrated in FIG. 11A, Nc=N1≤N2, and/or Mc=M1≤M2. For this example, the first block structure is a frequency domain extension of the common sub-block (e.g., adding more frequency domain resources such as a subcarriers or RBs to lower frequency and/or higher frequency and/or both lower and higher frequency (e.g., with the same number of frequency resources) to the common sub-block), and/or the second block structure is a time domain extension of the common sub-block (e.g., adding more time domain resources such as a number of slots or OFDM symbols before and/or after and/or both before and after the first block structure).
For one sub-example, the common sub-block has 2 OFDM symbols (e.g., according to 701 in FIG. 7, or 801 in FIG. 8), and/or the first block structure has additional frequency resources in these OFDM symbols (e.g., adding additional subcarriers or RBs mapped for PBCH or A-PBCH FDMed with the common sub-block), and/or the second block structure has 4 OFDM symbols (e.g., adding another 2 OFDM symbols mapped for PBCH or A-PBCH before and/or after the common sub-block).
For another sub-example, the common sub-block has 3 OFDM symbols (e.g., according to 702 or 703 in FIG. 7, or 802 in FIG. 8), and/or the first block structure has additional frequency resources in these OFDM symbols (e.g., adding additional subcarriers or RBs mapped for PBCH or A-PBCH FDMed with the common sub-block), and/or the second block structure has 4 or 5 OFDM symbols (e.g., adding another 1 or 2 OFDM symbols, respectively, mapped for PBCH or A-PBCH before and/or after the common sub-block).
For yet another sub-example, the common sub-block has 4 OFDM symbols (e.g., according to 704 or 705 or 706 in FIG. 7, or 803 in FIG. 8), and/or the first block structure has additional frequency resources in these OFDM symbols (e.g., adding additional subcarriers or RBs mapped for PBCH or A-PBCH FDMed with the common sub-block), and/or the second block structure has 5 or 6 or 7 OFDM symbols (e.g., adding another 1 or 2 or 3 OFDM symbols, respectively, mapped for PBCH or A-PBCH before and/or after the common sub-block).
For yet another sub-example, the common sub-block has 5 OFDM symbols (e.g., according to 707 or 708 or 709 or 710 in FIG. 7), and/or the first block structure has additional frequency resources in these OFDM symbols (e.g., adding additional subcarriers or RBs mapped for PBCH or A-PBCH FDMed with the common sub-block), and/or the second block structure has 6 or 7 OFDM symbols (e.g., adding another 1 or 2 OFDM symbols, respectively, mapped for PBCH or A-PBCH before and/or after the common sub-block).

In yet another example, as illustrated in FIG. 11B (where i=1 or i=2), Nc<N1=N2, and/or Mc=M1=M2, and the first block is a first one from 1101, 1102 or 1103 in FIG. 11B; and the second block is a second one from 1101, 1102 or 1103 in FIG. 11B. For this example, the first block structure and the second block structure have the same number of time and frequency resources, and the common sub-block is located differently in the frequency domain within the first block structure and the second block structure (e.g., 1101 is bottom aligned, 1102 is center aligned, and 1103 is top aligned).
For one sub-example, the common sub-block has 2 OFDM symbols (e.g., according to 701 in FIG. 7, or 801 in FIG. 8), and the first block structure and the second block structure have the same bandwidth and same signal/channel FDMed with the common sub-block (e.g., the same bandwidth is 18 RBs or 20 RBs or 22 RBs or 24 RBs, and/or empty RBs (mapped to 0) can be FDMed with common sub-block wherein the symbol is mapped for PSS, and/or PBCH can be FDMed with common sub-block wherein the symbol is mapped for SSS and/or PBCH).
For another sub-example, the common sub-block has 3 OFDM symbols (e.g., according to 702 or 703 in FIG. 7, or 802 in FIG. 8), and the first block structure and the second block structure have the same bandwidth and same signal/channel FDMed with the common sub-block (e.g., the same bandwidth is 18 RBs or 20 RBs or 22 RBs or 24 RBs, and/or empty RBs (mapped to 0) can be FDMed with common sub-block wherein the symbol is mapped for PSS, and/or PBCH can be FDMed with common sub-block wherein the symbol is mapped for SSS and/or PBCH).
For yet another sub-example, the common sub-block has 4 OFDM symbols (e.g., according to 704 or 705 or 706 in FIG. 7, or 803 in FIG. 8), and the first block structure and the second block structure have the same bandwidth and same signal/channel FDMed with the common sub-block (e.g., the same bandwidth is 18 RBs or 20 RBs or 22 RBs or 24 RBs, and/or empty RBs (mapped to 0) can be FDMed with common sub-block wherein the symbol is mapped for PSS, and/or PBCH can be FDMed with common sub-block wherein the symbol is mapped for SSS and/or PBCH).
For yet another sub-example, the common sub-block has 5 OFDM symbols (e.g., according to 707 or 708 or 709 or 710 in FIG. 7), and the first block structure and the second block structure have the same bandwidth and same signal/channel FDMed with the common sub-block (e.g., the same bandwidth is 18 RBs or 20 RBs or 22 RBs or 24 RBs, and/or empty RBs (mapped to 0) can be FDMed with common sub-block wherein the symbol is mapped for PSS, and/or PBCH can be FDMed with common sub-block wherein the symbol is mapped for SSS and/or PBCH).

In yet another example, as illustrated in FIG. 11C (where i=1 or i=2), Nc=N1=N2, and/or Mc<M1=M2, and the first block is a first one from 1111, 1112 or 1113 in FIG. 11C; and the second block is a second one from 1111, 1112 or 1113 in FIG. 11C. For this example, the first block structure and the second block structure have the same number of time and frequency resources, and the common sub-block is located differently in the time domain within the first block structure and the second block structure (e.g., 1111 is left aligned, 1112 is in the middle, and 1113 is right aligned). In one further consideration of the example, the first block structure and the second block structure can both refer to 1112 in FIG. 11C, and the common sub-block is with different starting symbols within the first block structure and the second block structure.

In the present disclosure, indication of the block structure based on the common sub-block is provided.

In one embodiment, when a UE receives a block or a common sub-block included in a block, the UE can determine a structure of the block, from the multiple block structures.

For one example, the UE can determine the structure of the block based on a frequency location of the block or the common sub-block.
For one instance, the frequency location can be a global synchronization channel number (GSCN).
For another instance, the frequency location can be an absolute radio frequency channel number (ARFCN).
For yet another instance, the frequency location can be further combined with a frequency location of a channel or a band including the block or the common block.

For another example, the UE can determine the structure of the block based on an indication in a signal or channel included in the block or the common sub-block.
For one instance, the indication can be carried by PSS (e.g., using different sequences and/or using different mapping orders of sequences to indicate block structures, such as each sequence and/or mapping order corresponds to one block structure).
For another instance, the indication can be carried by SSS (e.g., using different sequences and/or using different mapping orders of sequences to indicate block structures, such as each sequence and/or mapping order corresponds to one block structure).
For yet another instance, the indication can be carried by TSS (e.g., using different sequences and/or using different mapping orders of sequences to indicate block structures, such as each sequence and/or mapping order corresponds to one block structure).
For yet another instance, the indication can be carried by DM-RS of PBCH (e.g., using different sequences and/or using different mapping orders of sequences to indicate block structures, such as each sequence and/or mapping order corresponds to one block structure).
For yet another instance, the indication can be carried by the payload of a PBCH (e.g., using an explicit field in the master information block, and/or using an explicit field in the bit(s) generated in physical layer, and/or using information for generating scrambling sequence for PBCH to indicate block structures).
For yet another instance, the indication can be carried by the payload of an additional PBCH (e.g., using an explicit field in the master information block, and/or using an explicit field in the bit(s) generated in physical layer, and/or using information for generating scrambling sequence for PBCH to indicate block structures).

In another embodiment, a UE can be provided with a configuration or an indication, and the UE can determine a structure of the block, from the multiple block structures, based on the configuration or the indication.
For one example, the configuration can be a higher layer parameter (e.g., system information block, and/or dedicated radio resource control (RRC) parameter for a serving cell).
For another example, the indication can be a media access control (MAC) control element (CE).
For yet another example, the indication can be a downlink control information (DCI) format.

In the present disclosure, example UE procedures for using multiple block structures are provided.

In one embodiment, multiple block structures can be utilized for BS operating in multiple modes, wherein at least the first block structure is utilized for a first operating mode, and at least the second block structure is utilized for a second operating mode.

For one example, the first block structure can be utilized when the BS is operating with a network energy saving mode (e.g., a periodicity of the first block structure is with a first value, denoted as P1), and/or the second block structure can be utilized when the BS is not operating with the network energy saving mode (e.g., a periodicity of the second block structure is with a second value, denoted as P2).
For one further implementation, a reference frequency (e.g., center subcarrier or lowest subcarrier or highest subcarrier) of the common sub-block included in the first block structure and the second block structure is the same.
For another further implementation, P1≥P2.
For yet another further implementation, when a UE performs initial cell search, the UE can try to receive the common sub-block based on a periodicity of max(P1, P2) (or P1 if P1≥P2).
For yet another further implementation, when a UE performs measurement (e.g., L1 and/or L3 measurement), the UE can try to measure the common sub-block based on a periodicity of max(P1, P2) (or P1 if P1≥P2).
For yet another further implementation, the first block structure and the second block structure can be located on different synchronization raster entries.

For another example, the first block structure can be utilized when the BS is not operating with a network energy saving mode (e.g., a periodicity of the first block structure is with a first value, denoted as P1), and/or the second block structure can be utilized when the BS is operating with the network energy saving mode (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≤P2.
For yet another further implementation, when a UE performs initial cell search, the UE can try to receive the common sub-block based on a periodicity of max(P1, P2) (or P2 if P1≤P2).
For yet another further implementation, when a UE performs measurement (e.g., L1 and/or L3 measurement), the UE can try to measure the common sub-block based on a periodicity of max(P1, P2) (or P2 if P1≤P2).
For yet another further implementation, the first block structure and the second block structure can be located on different synchronization raster entries.

For one example, the first block structure can be utilized when a cell is operating as a PCell (e.g., a periodicity of the first block structure is with a first value, denoted as P1), and/or the second block structure can be utilized when a cell is operating as a SCell (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1 ≥P2.
For yet another further implementation, when a UE performs initial cell search, the UE can try to receive the common sub-block based on a periodicity of max(P1, P2) (or P1 if P1≥P2).
For yet another further implementation, when a UE performs measurement (e.g., L1 and/or L3 measurement), the UE can try to measure the common sub-block based on a periodicity of max(P1, P2) (or P1 if P1≥P2).
For yet another further implementation, the first block structure and the second block structure can be located on different synchronization raster entries.

For another example, the first block structure can be utilized when a cell is operating as a PCell (e.g., a periodicity of the first block structure is with a first value, denoted as P1), and/or the second block structure can be utilized when a cell is operating as a SCell (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≤P2.
For yet another further implementation, when a UE performs initial cell search, the UE can try to receive the common sub-block based on a periodicity of max(P1, P2) (or P2 if P1 ≤P2).
For yet another further implementation, when a UE performs measurement (e.g., L1 and/or L3 measurement), the UE can try to measure the common sub-block based on a periodicity of max(P1, P2) (or P2 if P1≤P2).
For yet another further implementation, the first block structure and the second block structure can be located on different synchronization raster entries.

For one example, the first block structure can be utilized when the block is transmitted in a periodic manner (e.g., a periodicity of the first block structure is with a first value, denoted as P1), and/or the second block structure can be utilized when the block is transmitted in an on-demand manner (e.g., a periodicity or an interval between two consecutive bursts of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≥P2.
For yet another further implementation, when a UE performs initial cell search, the UE can try to receive the common sub-block based on a periodicity of max(P1, P2) (or P1 if P1≥P2).
For yet another further implementation, when a UE performs measurement (e.g., L1 and/or L3 measurement), the UE can try to measure the common sub-block based on a periodicity of max(P1, P2) (or P1 if P1≥P2).
For yet another further implementation, the first block structure and the second block structure can be located on different synchronization raster entries.

For another example, the first block structure can be utilized when the block is transmitted in an on-demand manner (e.g., a periodicity or an interval between two consecutive bursts of the first block structure is with a first value, denoted as P1), and/or the second block structure can be utilized when the block is transmitted in a periodic manner (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≤P2.
For yet another further implementation, when a UE performs initial cell search, the UE can try to receive the common sub-block based on a periodicity of max(P1, P2) (or P2 if P1≤P2).
For yet another further implementation, when a UE performs measurement (e.g., L1 and/or L3 measurement), the UE can try to measure the common sub-block based on a periodicity of max(P1, P2) (or P2 if P1≤P2).
For yet another further implementation, the first block structure and the second block structure can be located on different synchronization raster entries.

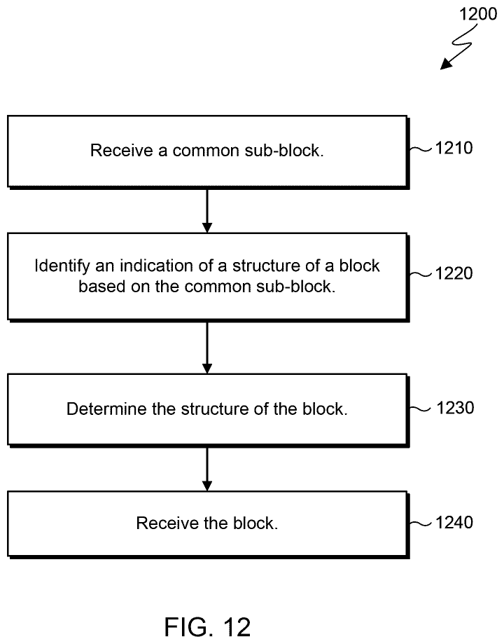

FIG. 12 illustrates an example method 1200 for using multiple block structures that may be performed by a UE in a wireless communication system according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with a UE receiving a common sub-block (1210). The UE then identifies an indication of a structure of a block based on the common sub-block (1220). The UE then determines the structure of the block (1230). The UE then receives the block (1240).

Although FIG. 12 illustrates one example method 1200 of the actions taken by the UE when utilizing multiple block structures, various changes may be made to FIG. 12. For example, while shown as a series of steps, various steps in FIG. 12 could overlap, occur in parallel, occur in a different order, or occur any number of times.

In another embodiment, multiple block structures can be utilized for multiple UE types, wherein at least the first block structure is utilized for a first type of UE, and at least the second block structure is utilized for a second type of UE.

For one example, the first block structure can be utilized by a 5G UE (e.g., a periodicity of the first block structure is with a first value, denoted as P1), and/or the second block structure can be utilized by a 6G UE (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≥P2.
For yet another further implementation, when a 5G UE performs initial cell search, the UE can try to receive the common sub-block based on a periodicity of max(P1, P2) (or P1 if P1≥P2).
For yet another further implementation, when a 6G UE performs initial cell search, the UE can try to receive the common sub-block based on a periodicity of max(P1, P2) (or P1 if P1≥P2).
For yet another further implementation, when a 5G UE performs measurement (e.g., L1 and/or L3 measurement), the UE can try to measure the common sub-block based on a periodicity of max(P1, P2) (or P1 if P1≥P2).
For yet another further implementation, when a 6G UE performs measurement (e.g., L1 and/or L3 measurement), the UE can try to measure the common sub-block based on a periodicity of max(P1, P2) (or P1 if P1≥P2).
For yet another further implementation, the first block structure and the second block structure can be located on different synchronization raster entries.

For another example, the first block structure can be utilized by a 6G UE (e.g., a periodicity of the first block structure is with a first value, denoted as P1), and/or the second block structure can be utilized by a 5G UE (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≤P2.
For yet another further implementation, when a 5G UE performs initial cell search, the UE can try to receive the common sub-block based on a periodicity of max(P1, P2) (or P2 if P1≤P2).
For yet another further implementation, when a 6G UE performs initial cell search, the UE can try to receive the common sub-block based on a periodicity of max(P1, P2) (or P2 if P1≤P2).
For yet another further implementation, when a 5G UE performs measurement (e.g., L1 and/or L3 measurement), the UE can try to measure the common sub-block based on a periodicity of max(P1, P2) (or P2 if P1≤P2).
For yet another further implementation, when a 6G UE performs measurement (e.g., L1 and/or L3 measurement), the UE can try to measure the common sub-block based on a periodicity of max(P1, P2) (or P2 if P1≤P2).
For yet another further implementation, the first block structure and the second block structure can be located on different synchronization raster entries.

For one example, the first block structure can be utilized by a first UE with normal or higher capability (e.g., a periodicity of the first block structure is with a first value, denoted as P1), and/or the second block structure can be utilized by a second UE with lower capability (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≥P2.
For yet another further implementation, when the first UE performs initial cell search, the first UE can try to receive the common sub-block based on a periodicity of max(P1, P2) (or P1 if P1≥P2).
For yet another further implementation, when the second UE performs initial cell search, the second UE can try to receive the common sub-block based on a periodicity of max(P1, P2) (or P1 if P1≥P2).
For yet another further implementation, when the first UE performs measurement (e.g., L1 and/or L3 measurement), the first UE can try to measure the common sub-block based on a periodicity of max(P1, P2) (or P1 if P1≥P2).
For yet another further implementation, when the second UE performs measurement (e.g., L1 and/or L3 measurement), the second UE can try to measure the common sub-block based on a periodicity of max(P1, P2) (or P1 if P1≥P2).
For yet another further implementation, the first block structure and the second block structure can be located on different synchronization raster entries.

For another example, the first block structure can be utilized by a 6G UE (e.g., a periodicity of the first block structure is with a first value, denoted as P1), and/or the second block structure can be utilized by a 5G UE (e.g., a periodicity of the second block structure is with a second value, denoted as P2).
For one further implementation, a reference frequency (e.g., center subcarrier or lowest subcarrier or highest subcarrier) of the common sub-block included in the first block structure and the second structure is the same.
For another further implementation, P1≤P2.
For yet another further implementation, when the first UE performs initial cell search, the first UE can try to receive the common sub-block based on a periodicity of max(P1, P2) (or P2 if P1≤P2).
For yet another further implementation, when the second UE performs initial cell search, the second UE can try to receive the common sub-block based on a periodicity of max(P1, P2) (or P2 if P1≤P2).
For yet another further implementation, when the first UE performs measurement (e.g., L1 and/or L3 measurement), the first UE can try to measure the common sub-block based on a periodicity of max(P1, P2) (or P2 if P1≤P2).
For yet another further implementation, when the second UE performs measurement (e.g., L1 and/or L3 measurement), the second UE can try to measure the common sub-block based on a periodicity of max(P1, P2) (or P2 if P1≤P2).
For yet another further implementation, the first block structure and the second block structure can be located on different synchronization raster entries.

For one example, the first block structure can be utilized by a synchronization raster with a first channelization, and/or the second block structure can be utilized by the synchronization raster with a second channelization. The relative frequency locations of the synchronization raster within the first channelization and the second channelization can be different.
For one further implementation, a reference frequency (e.g., center subcarrier or lowest subcarrier or highest subcarrier) of the common sub-block included in the first block structure and the second structure is the same.
For another further implementation, when a UE performs initial cell search, the UE can try to receive the common sub-block.
For yet another further implementation, when a UE performs measurement (e.g., L1 and/or L3 measurement), the UE can try to measure the common sub-block.

In the present disclosure, example SSB structures are provided.

In one embodiment, one synchronization signals block (SSB) can include N_symb OFDM symbols in the time domain.
For one further consideration, the N_symb OFDM symbols of the SSB can be indexed from 0 to N_symb−1 in an increasing order in the time domain.
For another further consideration, the SSB can also be multiplexed with physical broadcast channel (PBCH).
For yet another further consideration, the N_symb OFDM symbols can be consecutive in the time domain.
For yet another further consideration, the N_symb OFDM symbols can be consecutive downlink OFDM symbols in the time domain.

For one example, within the N_symb OFDM symbols of the SSB, N_1 number of the OFDM symbols are mapped for a first type of signal(s)/channel(s), and the set of indexes of the N_1 number of the OFDM symbols can be denoted as S_1.

For another example, within the N_symb OFDM symbols of the SSB, N_2 number of the OFDM symbols are mapped for a second type of signal(s)/channel(s), and the set of indexes of the N_2 number of the OFDM symbols can be denoted as S_2.

For yet another example, within the N_symb OFDM symbols of the SSB, N_3 number of the OFDM symbols are mapped for a third type of signal(s)/channel(s), and the set of indexes of the N_3 number of the OFDM symbols can be denoted as S_3.

For one example, the OFDM symbol for the first type of signal(s)/channel(s) can at least include a primary synchronization signal (PSS).
For one sub-example, the bandwidth of the OFDM symbol can be N_RB RBs (e.g., 12·N_RB subcarriers), and a sequence for PSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for PSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.

For another example, the OFDM symbol for the first type of signal(s)/channel(s) can at least include a secondary synchronization signal (SSS).
For one sub-example, the bandwidth of the OFDM symbol can be N_RB RBs (e.g., 12·N_RB subcarriers), and a sequence for SSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for SSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.

For yet another example, the OFDM symbol for the first type of signal(s)/channel(s) can at least include a physical broadcast channel (PBCH), e.g., including a demodulation reference signal (DM-RS) of the PBCH, if supported.
For one sub-example, the bandwidth of the OFDM symbol can be N_RB RBs (e.g., 12·N_RB subcarriers).

For one example, the OFDM symbol for the second type of signal(s)/channel(s) can at least include a primary synchronization signal (PSS).
For one sub-example, the bandwidth of the OFDM symbol can be N_RB RBs (e.g., 12·N_RB subcarriers), and a sequence for PSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for PSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.

For another example, the OFDM symbol for the second type of signal(s)/channel(s) can at least include a secondary synchronization signal (SSS).
For one sub-example, the bandwidth of the OFDM symbol can be N_RB RBs (e.g., 12·N_RB subcarriers), and a sequence for SSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for SSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.

For yet another example, the OFDM symbol for the second type of signal(s)/channel(s) can at least include a physical broadcast channel (PBCH), e.g., including a demodulation reference signal (DM-RS) of the PBCH, if supported.
For one sub-example, the bandwidth of the OFDM symbol can be N_RB RBs (e.g., 12·N_RB subcarriers).

For one example, the OFDM symbol for the third type of signal(s)/channel(s) can at least include a primary synchronization signal (PSS).
For one sub-example, the bandwidth of the OFDM symbol can be N_RB RBs (e.g., 12·N_RB subcarriers), and a sequence for PSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for PSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.

For another example, the OFDM symbol for the third type of signal(s)/channel(s) can at least include a secondary synchronization signal (SSS).
For one sub-example, the bandwidth of the OFDM symbol can be N_RB RBs (e.g., 12·N_RB subcarriers), and a sequence for SSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for SSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.

For yet another example, the OFDM symbol for the third type of signal(s)/channel(s) can at least include a physical broadcast channel (PBCH), e.g., including a demodulation reference signal (DM-RS) of the PBCH, if supported.
For one sub-example, the bandwidth of the OFDM symbol can be N_RB RBs (e.g., 12·N_RB subcarriers).

For one example, N_RB can be pre-determined, e.g., as 11, or as 12, or as 14, or as 16, or as 18, or as 20, or as 24.

For another example, N_RB can be configured by the base station, e.g., using higher layer parameter.

For yet another example, N_RB can be indicated by the base station, e.g., using control information.

For one example, N_symb can be pre-determined, e.g., according to one example of this disclosure.

For another example, N_symb can be configured by the base station, e.g., using higher layer parameter.

For yet another example, N_symb can be indicated by the base station, e.g., using control information.

For one example, the SSB structure can be pre-determined, e.g., according to one example of this disclosure. For instance, the SSB structure can be determined based on at least one of N_symb, or N_RB, or S_1, or S_2, or S_3.

For another example, the SSB structure can be configured by the base station. For one instance, at least one of N_symb, or N_RB, or S_1, or S_2, or S_3 can be provided by a higher layer parameter. For another instance, at least one of the example SSB structure in the disclosure can be configured by the base station.

For another example, the SSB structure can be indicated by the base station. For one instance, at least one of N_symb, or N_RB, or S_1, or S_2, or S_3 can be indicated by control information. For another instance, at least one of the example SSB structure in the disclosure can be indicated by control information.

For one example, at least one of the example SSB structures in the present disclosure can be supported. One or multiple example SSB structures can be supported for different use cases, such as different bands, and/or different frequency ranges, and/or different subcarrier spacings, and/or different operation mode of the cell (e.g., PCell, SCell, or PSCell), and/or different UE types.

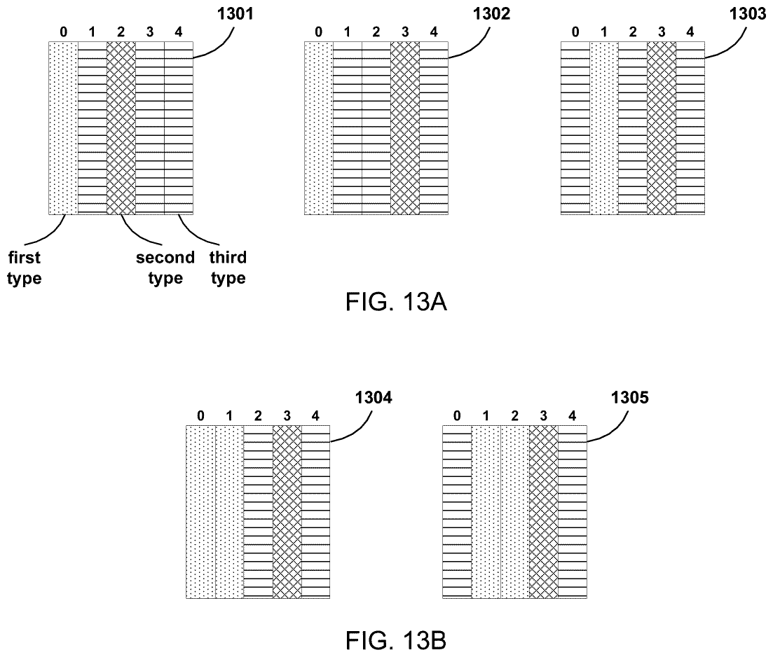

FIGS. 13A and 13B illustrate examples of SSB structures according to embodiments of the present disclosure. More particularly, FIGS. 13A and 13B illustrate SSB structures with 5 symbols. For example, these SSB structures can be implemented by BS 102 of FIG. 1. These examples are for illustration only and other embodiments can be used without departing from the scope of the present disclosure.

In one sub-embodiment, N_symb=5, e.g., N_1=1, N_2=1, and N_3=3.

For a first example (e.g., 1301 in FIG. 13A) of this sub-embodiment, N_1=1, S_1={0}, N_2=1, S_2={2}, N_3=3, S_3={1, 3, 4}.

For a second example (e.g., 1302 in FIG. 13A) of this sub-embodiment, N_1=1, S_1={0}, N_2=1, S_2={3}, N_3=3, S_3={1, 2, 4}.

For a third example (e.g., 1303 in FIG. 13A) of this sub-embodiment, N_1=1, S_1={1}, N_2=1, S_2={3}, N_3=3, S_3={0, 2, 4}.

In one sub-embodiment, N_symb=5, e.g., N_1=2, N_2=1, and N_3=2.

For a fourth example (e.g., 1304 in FIG. 13B) of this sub-embodiment, N_1=2, S_1={0, 1}, N_2=1, S_2={3}, N_3=2, S_3={2, 4}.

For a fifth example (e.g., 1305 in FIG. 13B) of this sub-embodiment, N_1=2, S_1={1, 2}, N_2=1, S_2={3}, N_3=2, S_3={0, 4}.

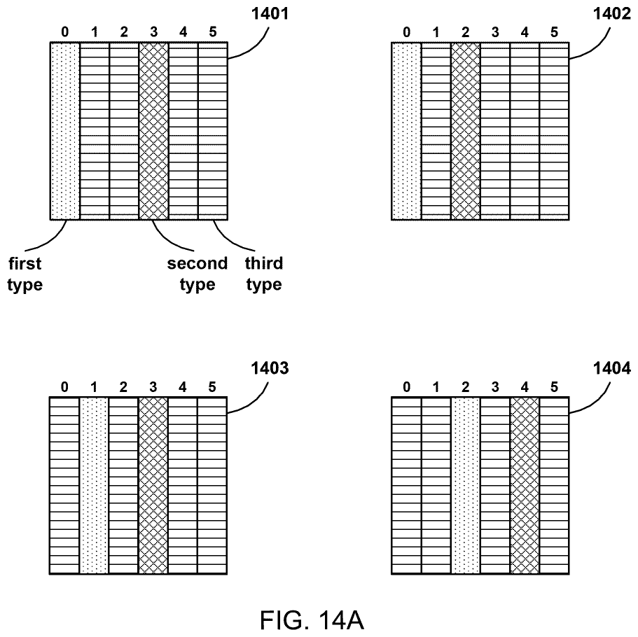

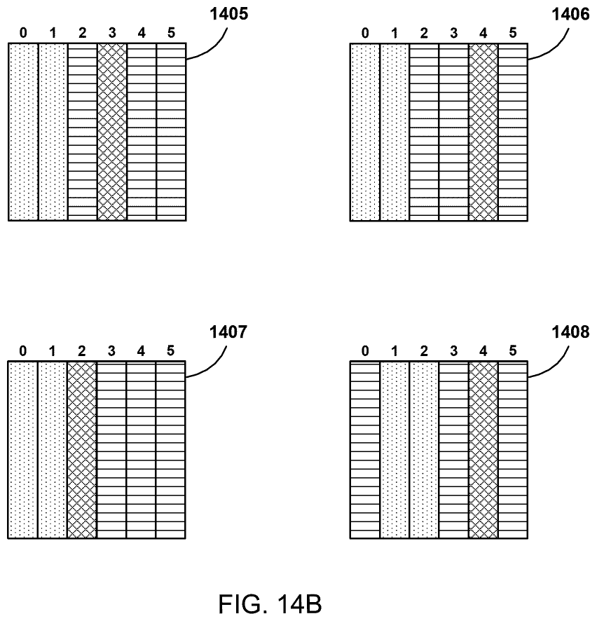

FIGS. 14A and 14B illustrate examples of SSB structures according to embodiments of the present disclosure. More particularly, FIGS. 14A and 14B illustrate SSB structures with 6 symbols. For example, these SSB structures can be implemented by BS 102 of FIG. 1. These examples are for illustration only and other embodiments can be used without departing from the scope of the present disclosure.

In one sub-embodiment, N_symb=6, e.g., N_1=1, N_2=1, and N_3=4.

For a first example (e.g., 1401 in FIG. 14A) of this sub-embodiment, N_1=1, S_1={0}, N_2=1, S_2={3}, N_3=4, S_3={1, 2, 4, 5}.

For a second example (e.g., 1402 in FIG. 14A) of this sub-embodiment, N_1=1, S_1={0}, N_2=1, S_2={2}, N_3=4, S_3={1, 3, 4, 5}.

For a third example (e.g., 1403 in FIG. 14A) of this sub-embodiment, N_1=1, S_1={1}, N_2=1, S_2={3}, N_3=4, S_3={0, 2, 4, 5}.

For a fourth example (e.g., 1404 in FIG. 14A) of this sub-embodiment, N_1=1, S_1={2}, N_2=1, S_2={4}, N_3=4, S_3={0, 1, 3, 5}.

In one sub-embodiment, N_symb=6, e.g., N_1=2, N_2=1, and N_3=3.

For a fifth example (e.g., 1405 in FIG. 14B) of this sub-embodiment, N_1=2, S_1={0, 1}, N_2=1, S_2={3}, N_3=3, S_3={2, 4, 5}.

For a sixth example (e.g., 1406 in FIG. 14B) of this sub-embodiment, N_1=2, S_1={0, 1}, N_2=1, S_2={4}, N_3=3, S_3={2, 3, 5}.

For a seventh example (e.g., 1407 in FIG. 14B) of this sub-embodiment, N_1=2, S_1={0, 1}, N_2=1, S_2={2}, N_3=3, S_3={3, 4, 5}.

For an eighth example (e.g., 1408 in FIG. 14B) of this sub-embodiment, N_1=2, S_1={1, 2}, N_2=1, S_2={4}, N_3=3, S_3={0, 3, 5}.

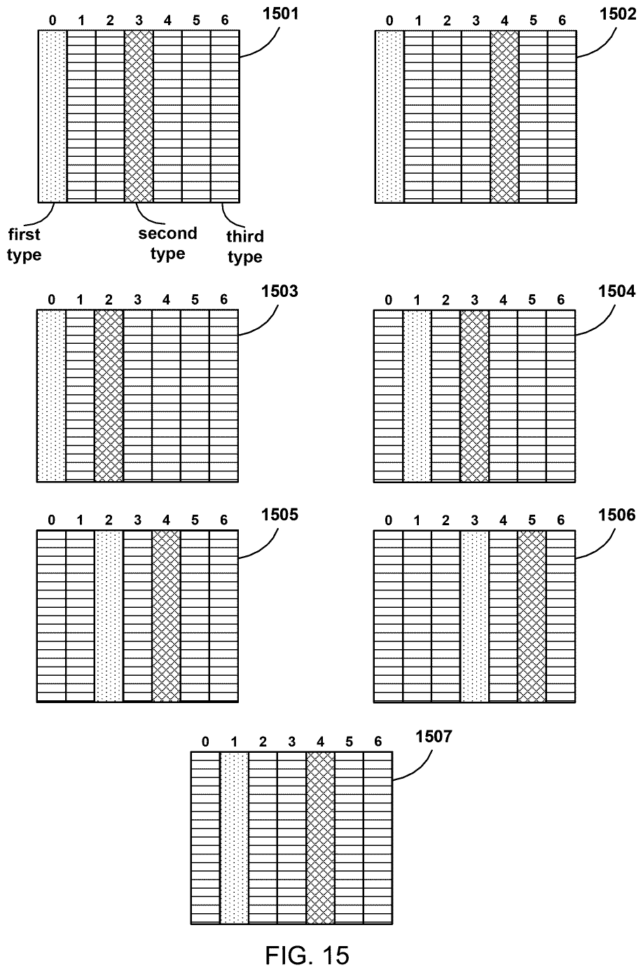

FIGS. 15-17 illustrate examples of SSB structures according to embodiments of the present disclosure. More particularly, FIGS. 15-17 illustrate SSB structures with 7 symbols. For example, these SSB structures can be implemented by BS 102 of FIG. 1. These examples are for illustration only and other embodiments can be used without departing from the scope of the present disclosure.

In one sub-embodiment, N_symb=7, e.g., N_1=1, N_2=1, and N_3=5.

For a first example (e.g., 1501 in FIG. 15) of this sub-embodiment, N_1=1, S_1={0}, N_2=1, S_2={3}, N_3=5, S_3={1, 2, 4, 5, 6}.

For a second example (e.g., 1502 in FIG. 15) of this sub-embodiment, N_1=1, S_1 {0}, N_2=1, S_2={4}, N_3=5, S_3={1, 2, 3, 5, 6}.

For a third example (e.g., 1503 in FIG. 15) of this sub-embodiment, N_1=1, S_1={0}, N_2=1, S_2={2}, N_3=5, S_3={1, 3, 4, 5, 6}.

For a fourth example (e.g., 1504 in FIG. 15) of this sub-embodiment, N_1=1, S_1={1}, N_2=1, S_2={3}, N_3=5, S_3={0, 2, 4, 5, 6}.

For a fifth example (e.g., 1505 in FIG. 15) of this sub-embodiment, N_1=1, S_1={2}, N_2=1, S_2={4}, N_3=5, S_3={0, 1, 3, 5, 6}.

For a sixth example (e.g., 1506 in FIG. 15) of this sub-embodiment, N_1=1, S_1={3}, N_2=1, S_2={5}, N_3=5, S_3={0, 1, 2, 4, 6}.

For a seventh example (e.g., 1507 in FIG. 15) of this sub-embodiment, N_1=1, S_1={1}, N_2=1, S_2={4}, N_3=5, S_3={0, 2, 3, 5, 6}.

In one sub-embodiment, N_symb=7, e.g., N_1=2, N_2=2, and N_3=3.

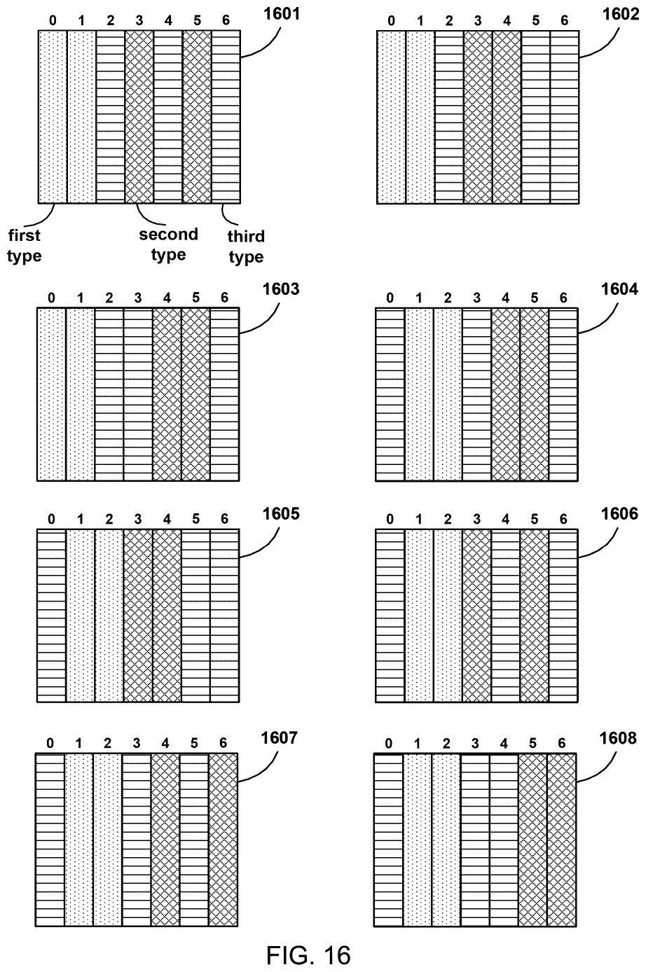

For a first example (e.g., 1601 in FIG. 16) of this sub-embodiment, N_1=2, S_1={0, 1}, N_2=2, S_2={3, 5}, N_3=3, S_3={2, 4, 6}.

For a second example (e.g., 1602 in FIG. 16) of this sub-embodiment, N_1=2, S_1 {0, 1}, N_2=2, S_2={3, 4}, N_3=3, S_3={2, 5, 6}.

For a third example (e.g., 1603 in FIG. 16) of this sub-embodiment, N_1=2, S_1={0, 1}, N_2=2, S_2={4, 5}, N_3=3, S_3={2, 3, 6}.

For a fourth example (e.g., 1604 in FIG. 16) of this sub-embodiment, N_1=2, S_1={1, 2}, N_2=2, S_2={4, 5}, N_3=3, S_3={0, 3, 6}.

For a fifth example (e.g., 1605 in FIG. 16) of this sub-embodiment, N_1=2, S_1={1, 2}, N_2=2, S_2={3, 4}, N_3=3, S_3={0, 5, 6}.

For a sixth example (e.g., 1606 in FIG. 16) of this sub-embodiment, N_1=2, S_1={1, 2}, N_2=2, S_2={3, 5}, N_3=3, S_3={0, 4, 6}.

For a seventh example (e.g., 1607 in FIG. 16) of this sub-embodiment, N_1=2, S_1={1, 2}, N_2=2, S_2={4, 6}, N_3=3, S_3={0, 3, 5}.

For an eighth example (e.g., 1608 in FIG. 16) of this sub-embodiment, N_1=2, S_1={1, 2}, N_2=2, S_2={5, 6}, N_3=3, S_3={0, 3, 4}.

In one sub-embodiment, N_symb=7, e.g., N_1=2, N_2=1, and N_3=4.

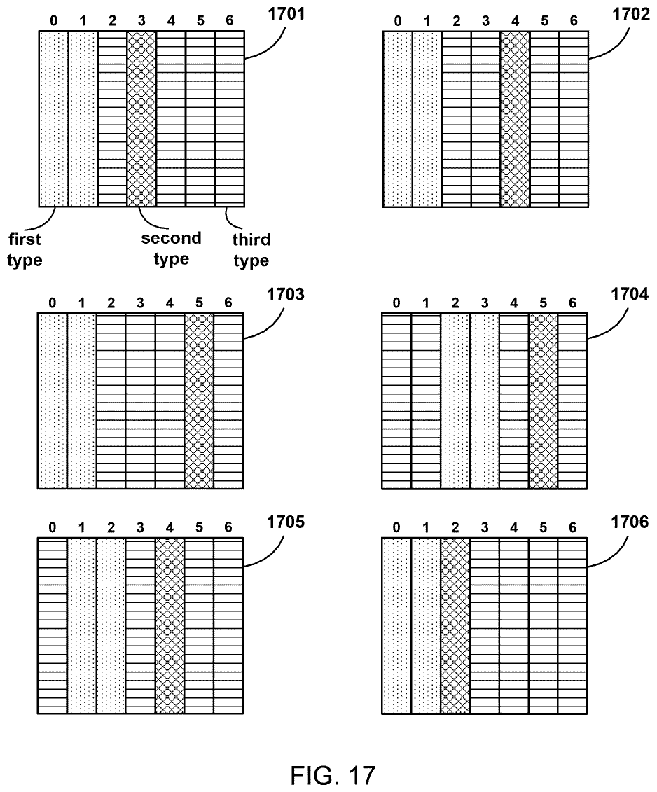

For a first example (e.g., 1701 in FIG. 17) of this sub-embodiment, N_1=2, S_1={0, 1}, N_2=1, S_2={3}, N_3=4, S_3={2, 4, 5, 6}.

For a second example (e.g., 1702 in FIG. 17) of this sub-embodiment, N_1=2, S_1 {0, 1}, N_2=1, S_2={4}, N_3=4, S_3={2, 3, 5, 6}.

For a third example (e.g., 1703 in FIG. 17) of this sub-embodiment, N_1=2, S_1={0, 1}, N_2=1, S_2={5}, N_3=4, S_3={2, 3, 4, 6}.

For a fourth example (e.g., 1704 in FIG. 17) of this sub-embodiment, N_1=2, S_1={2, 3}, N_2=1, S_2={5}, N_3=4, S_3={0, 1, 4, 6}.

For a fifth example (e.g., 1705 in FIG. 17) of this sub-embodiment, N_1=2, S_1={1, 2}, N_2=1, S_2={4}, N_3=4, S_3={0, 3, 5, 6}.

For a sixth example (e.g., 1706 in FIG. 17) of this sub-embodiment, N_1=2, S_1={0, 1}, N_2=1, S_2={2}, N_3=4, S_3={3, 4, 5, 6}.

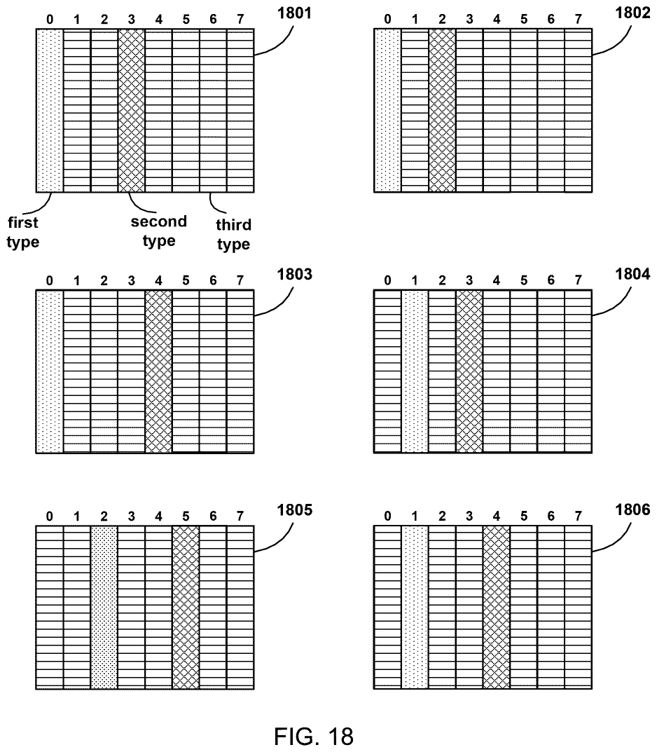

FIGS. 18-22 illustrate examples of SSB structures according to embodiments of the present disclosure. More particularly, FIGS. 18-22 illustrate SSB structures with 8 symbols. For example, these SSB structures can be implemented by BS 102 of FIG. 1. These examples are for illustration only and other embodiments can be used without departing from the scope of the present disclosure.

In one sub-embodiment, N_symb=8, e.g., N_1=1, N_2=1, and N_3=6.

For a first example (e.g., 1801 in FIG. 18) of this sub-embodiment, N_1=1, S_1={0}, N_2=1, S_2={3}, N_3=6, S_3={1, 2, 4, 5, 6, 7}.

For a second example (e.g., 1802 in FIG. 18) of this sub-embodiment, N_1=1, S_1 {0}, N_2=1, S_2={2}, N_3=6, S_3={1, 3, 4, 5, 6, 7}.

For a third example (e.g., 1803 in FIG. 18) of this sub-embodiment, N_1=1, S_1={0}, N_2=1, S_2={4}, N_3=6, S_3={1, 2, 3, 5, 6, 7}.

For a fourth example (e.g., 1804 in FIG. 18) of this sub-embodiment, N_1=1, S_1={1}, N_2=1, S_2={3}, N_3=6, S_3={0, 2, 4, 5, 6, 7}.

For a fifth example (e.g., 1805 in FIG. 18) of this sub-embodiment, N_1=1, S_1={2}, N_2=1, S_2={5}, N_3=6, S_3={0, 1, 3, 4, 6, 7}.

For a sixth example (e.g., 1806 in FIG. 18) of this sub-embodiment, N_1=1, S_1={1}, N_2=1, S_2={4}, N_3=6, S_3={0, 2, 3, 5, 6, 7}.

In one sub-embodiment, N_symb=8, e.g., N_1=2, N_2=2, and N_3=4.

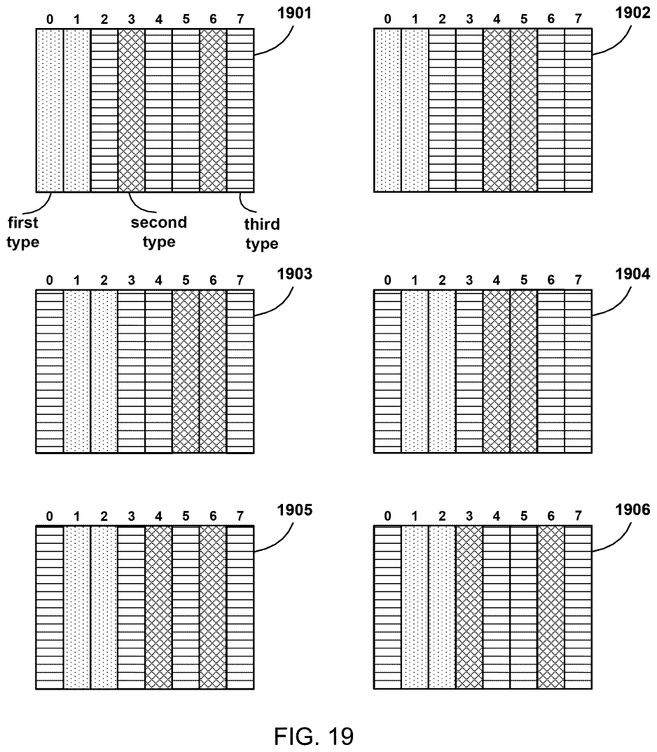

For a first example (e.g., 1901 in FIG. 19) of this sub-embodiment, N_1=2, S_1={0, 1}, N_2=2, S_2={3, 6}, N_3=4, S_3={2, 4, 5, 7}.

For a second example (e.g., 1902 in FIG. 19) of this sub-embodiment, N_1=2, S_1 {0, 1}, N_2=2, S_2={4, 5}, N_3=4, S_3={2, 3, 6, 7}.

For a third example (e.g., 1903 in FIG. 19) of this sub-embodiment, N_1=2, S_1={1, 2}, N_2=2, S_2={5, 6}, N_3=4, S_3={0, 3, 4, 7}.

For a fourth example (e.g., 1904 in FIG. 19) of this sub-embodiment, N_1=2, S_1={1, 2}, N_2=2, S_2={4, 5}, N_3=4, S_3={0, 3, 6, 7}.

For a fifth example (e.g., 1905 in FIG. 19) of this sub-embodiment, N_1=2, S_1={1, 2}, N_2=2, S_2={4, 6}, N_3=4, S_3={0, 3, 5, 7}.

For a sixth example (e.g., 1906 in FIG. 19) of this sub-embodiment, N_1=2, S_1={1, 2}, N_2=2, S_2={3, 6}, N_3=4, S_3={0, 4, 5, 7}.

In one sub-embodiment, N_symb=8, e.g., N_1=2, N_2=1, and N_3=5.

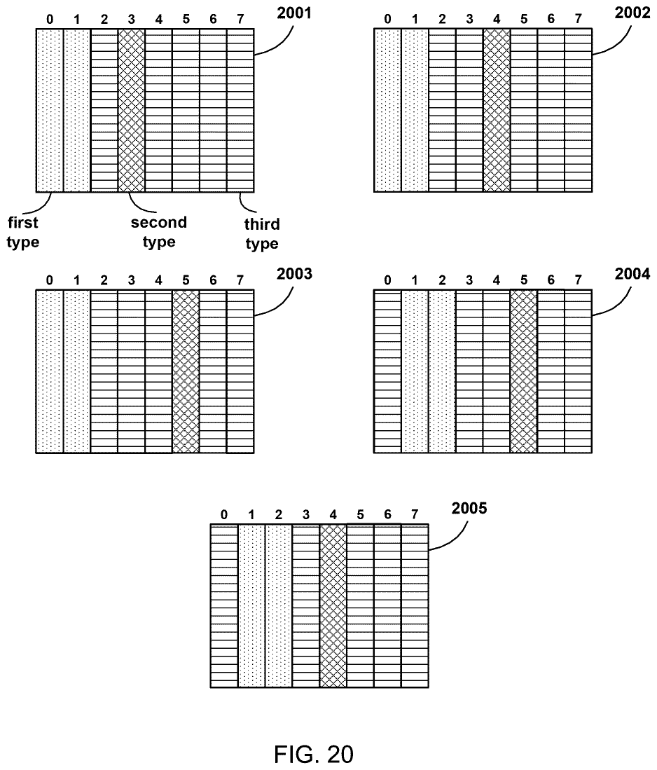

For a first example (e.g., 2001 in FIG. 20) of this sub-embodiment, N_1=2, S_1={0, 1}, N_2=1, S_2={3}, N_3=5, S_3={2, 4, 5, 6, 7}.

For a second example (e.g., 2002 in FIG. 20) of this sub-embodiment, N_1=2, S_1 {0, 1}, N_2=1, S_2={4}, N_3=5, S_3={2, 3, 5, 6, 7}.

For a third example (e.g., 2003 in FIG. 20) of this sub-embodiment, N_1=2, S_1={0, 1}, N_2=1, S_2={5}, N_3=5, S_3={2, 3, 4, 6, 7}.

For a fourth example (e.g., 2004 in FIG. 20) of this sub-embodiment, N_1=2, S_1={1, 2}, N_2=1, S_2={5}, N_3=5, S_3={0, 3, 4, 6, 7}.

For a fifth example (e.g., 2005 in FIG. 20) of this sub-embodiment, N_1=2, S_1={1, 2}, N_2=1, S_2={4}, N_3=5, S_3={0, 3, 5, 6, 7}.

In one sub-embodiment, N_symb=8, e.g., N_1=3, N_2=1, and N_3=4.

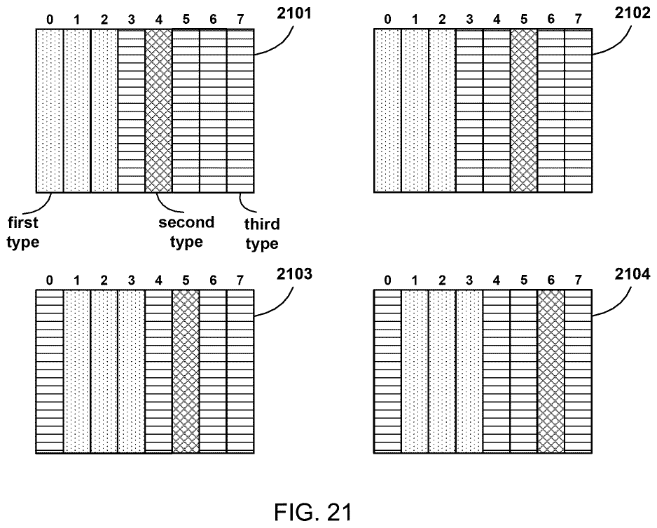

For a first example (e.g., 2101 in FIG. 21) of this sub-embodiment, N_1=3, S_1={0, 1, 2}, N_2=1, S_2={4}, N_3=4, S_3={3, 5, 6, 7}.

For a second example (e.g., 2102 in FIG. 21) of this sub-embodiment, N_1=3, S_1 {0, 1, 2}, N_2=1, S_2={5}, N_3=4, S_3={3, 4, 6, 7}.

For a third example (e.g., 2103 in FIG. 21) of this sub-embodiment, N_1=3, S_1={1, 2, 3}, N_2=1, S_2={5}, N_3=4, S_3={0, 4, 6, 7}.

For a fourth example (e.g., 2104 in FIG. 21) of this sub-embodiment, N_1=3, S_1={1, 2, 3}, N_2=1, S_2={6}, N_3=4, S_3={0, 4, 5, 7}.

In one sub-embodiment, N_symb=8, e.g., N_1=3, N_2=2, and N_3=3.

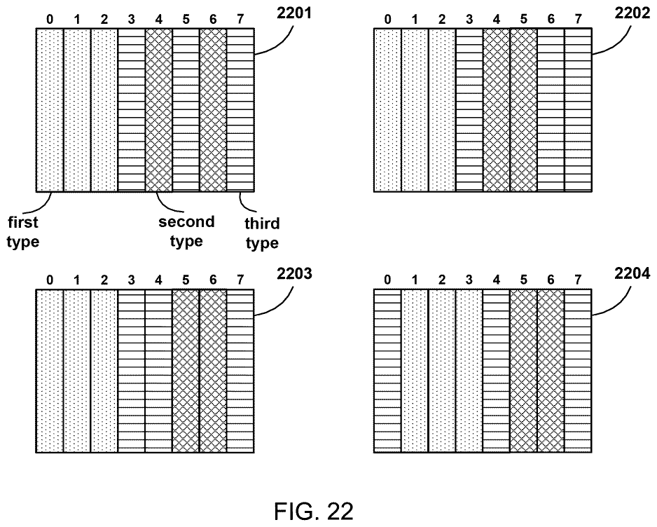

For a first example (e.g., 2201 in FIG. 22) of this sub-embodiment, N_1=3, S_1={0, 1, 2}, N_2=2, S_2={4, 6}, N_3=3, S_3={3, 5, 7}.

For a second example (e.g., 2202 in FIG. 22) of this sub-embodiment, N_1=3, S_1 {0, 1, 2}, N_2=2, S_2={4, 5}, N_3=3, S_3={3, 6, 7}.

For a third example (e.g., 2203 in FIG. 22) of this sub-embodiment, N_1=3, S_1={0, 1, 2}, N_2=2, S_2={5, 6}, N_3=3, S_3={3, 4, 7}.

For a fourth example (e.g., 2204 in FIG. 22) of this sub-embodiment, N_1=3, S_1={1, 2, 3}, N_2=2, S_2={5, 6}, N_3=3, S_3={0, 4, 7}.

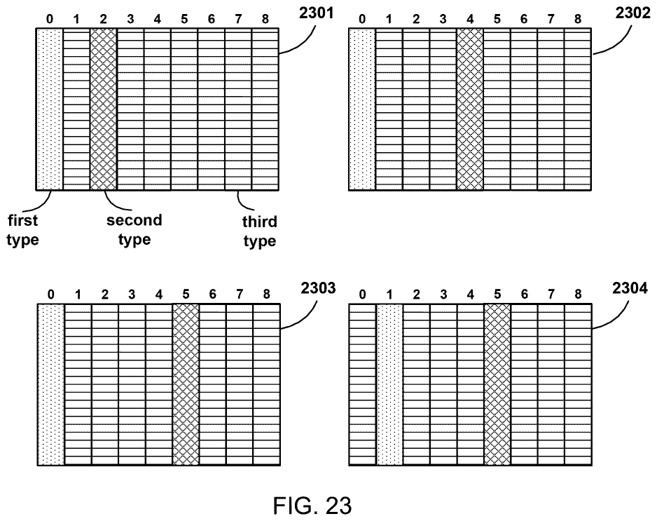

FIGS. 23-27 illustrate examples of SSB structures according to embodiments of the present disclosure. More particularly, FIGS. 23-27 illustrate SSB structures with 9 symbols. For example, these SSB structures can be implemented by BS 102 of FIG. 1. These examples are for illustration only and other embodiments can be used without departing from the scope of the present disclosure.

In one sub-embodiment, N_symb=9, e.g., N_1=1, N_2=1, and N_3=7.

For a first example (e.g., 2301 in FIG. 23) of this sub-embodiment, N_1=1, S_1={0}, N_2=1, S_2={2}, N_3=7, S_3={1, 3, 4, 5, 6, 7, 8}.

For a second example (e.g., 2302 in FIG. 23) of this sub-embodiment, N_1=1, S_1 {0}, N_2=1, S_2={4}, N_3=7, S_3={1, 2, 3, 5, 6, 7, 8}.

For a third example (e.g., 2303 in FIG. 23) of this sub-embodiment, N_1=1, S_1={0}, N_2=1, S_2={5}, N_3=7, S_3={1, 2, 3, 4, 6, 7, 8}.

For a fourth example (e.g., 2304 in FIG. 23) of this sub-embodiment, N_1=1, S_1={1}, N_2=1, S_2={5}, N_3=7, S_3={0, 2, 3, 4, 6, 7, 8}.

In one sub-embodiment, N_symb=9, e.g., N_1=2, N_2=2, and N_3=5.

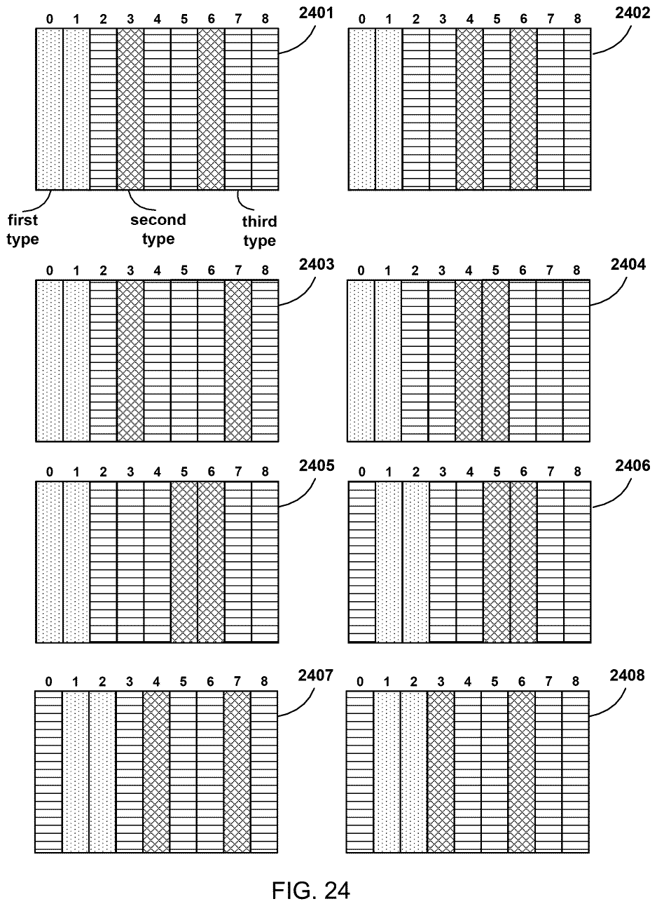

For a first example (e.g., 2401 in FIG. 24) of this sub-embodiment, N_1=2, S_1={0, 1}, N_2=2, S_2={3, 6}, N_3=5, S_3={2, 4, 5, 7, 8}.

For a second example (e.g., 2402 in FIG. 24) of this sub-embodiment, N_1=2, S_1 ={0, 1}, N_2=2, S_2={4, 6}, N_3=5, S_3={2, 3, 5, 7, 8}.

For a third example (e.g., 2403 in FIG. 24) of this sub-embodiment, N_1=2, S_1={0, 1}, N_2=2, S_2={3, 7}, N_3=5, S_3={2, 4, 5, 6, 8}.

For a fourth example (e.g., 2404 in FIG. 24) of this sub-embodiment, N_1=2, S_1 ={0, 1}, N_2=2, S_2={4, 5}, N_3=5, S_3={2, 3, 6, 7, 8}.

For a fifth example (e.g., 2405 in FIG. 24) of this sub-embodiment, N_1=2, S_1={0, 1}, N_2=2, S_2={5, 6}, N_3=5, S_3={2, 3, 4, 7, 8}.

For a sixth example (e.g., 2406 in FIG. 24) of this sub-embodiment, N_1=2, S_1={1, 2}, N_2=2, S_2={5, 6}, N_3=5, S_3={0, 3, 4, 7, 8}.

For a seventh example (e.g., 2407 in FIG. 24) of this sub-embodiment, N_1=2, S_1={1, 2}, N_2=2, S_2={4, 7}, N_3=5, S_3={0, 3, 5, 6, 8}.

For an eighth example (e.g., 2408 in FIG. 24) of this sub-embodiment, N_1=2, S_1={1, 2}, N_2=2, S_2={3, 6}, N_3=5, S_3={0, 4, 5, 7, 8}.

In one sub-embodiment, N_symb=9, e.g., N_1=2, N_2=1, and N_3=6.

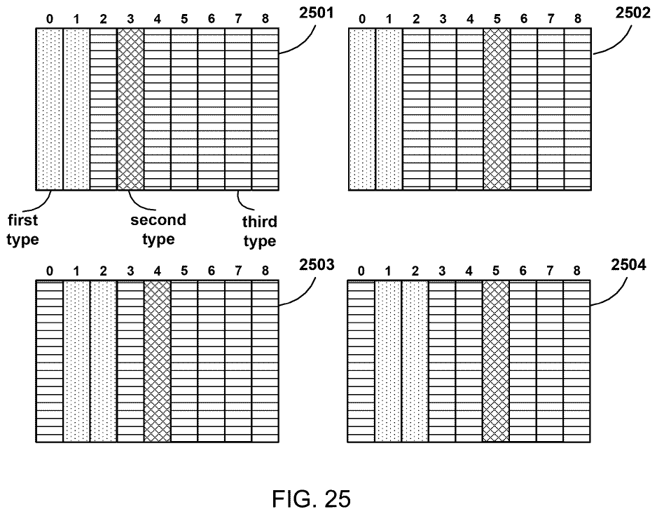

For a first example (e.g., 2501 in FIG. 25) of this sub-embodiment, N_1=2, S_1={0, 1}, N_2=1, S_2={3}, N_3=6, S_3={2, 4, 5, 6, 7, 8}.

For a second example (e.g., 2502 in FIG. 25) of this sub-embodiment, N_1=2, S_1 {0, 1}, N_2=1, S_2={5}, N_3=6, S_3={2, 3, 4, 6, 7, 8}.

For a third example (e.g., 2503 in FIG. 25) of this sub-embodiment, N_1=2, S_1={1, 2}, N_2=1, S_2={4}, N_3=6, S_3={0, 3, 5, 6, 7, 8}.

For a fourth example (e.g., 2504 in FIG. 25) of this sub-embodiment, N_1=2, S_1={1, 2}, N_2=1, S_2={5}, N_3=6, S_3={0, 3, 4, 6, 7, 8}.

In one sub-embodiment, N_symb=9, e.g., N_1=3, N_2=1, and N_3=5.

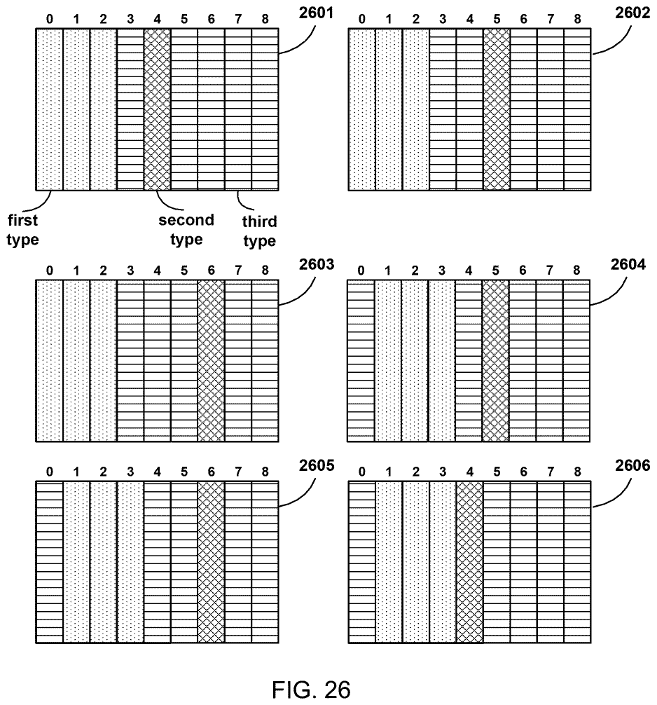

For a first example (e.g., 2601 in FIG. 26) of this sub-embodiment, N_1=3, S_1={0, 1, 2}, N_2=1, S_2={4}, N_3=5, S_3={3, 5, 6, 7, 8}.

For a second example (e.g., 2602 in FIG. 26) of this sub-embodiment, N_1=3, S_1 {0, 1, 2}, N_2=1, S_2={5}, N_3=5, S_3={3, 4, 6, 7, 8}.

For a third example (e.g., 2603 in FIG. 26) of this sub-embodiment, N_1=3, S_1={0, 1, 2}, N_2=1, S_2={6}, N_3=5, S_3={3, 4, 5, 7, 8}.

For a fourth example (e.g., 2604 in FIG. 26) of this sub-embodiment, N_1=3, S_1={1, 2, 3}, N_2=1, S_2={5}, N_3=5, S_3={0, 4, 6, 7, 8}.

For a fifth example (e.g., 2605 in FIG. 26) of this sub-embodiment, N_1=3, S_1={1, 2, 3}, N_2=1, S_2={6}, N_3=5, S_3={0, 4, 5, 7, 8}.

For a sixth example (e.g., 2606 in FIG. 26) of this sub-embodiment, N_1=3, S_1={1, 2, 3}, N_2=1, S_2={4}, N_3=5, S_3={0, 5, 6, 7, 8}.

In one sub-embodiment, N_symb=9, e.g., N_1=3, N_2=2, and N_3=4.

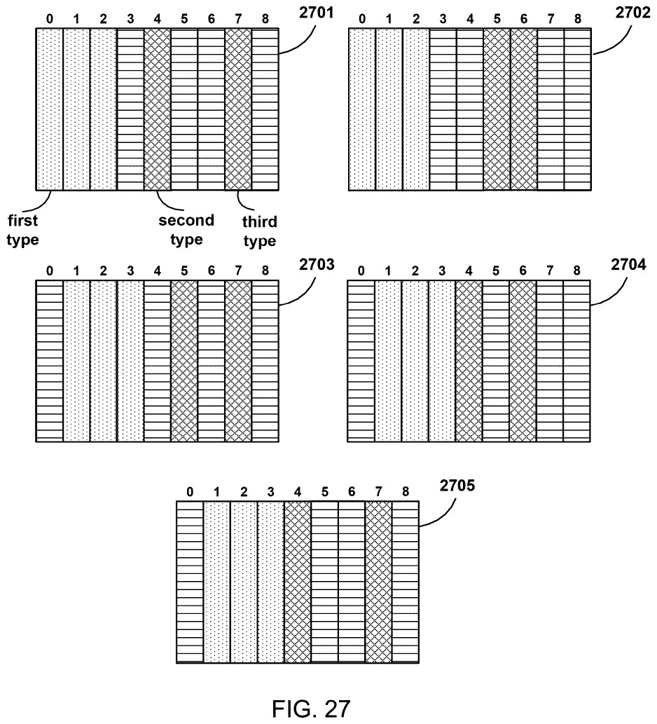

For a first example (e.g., 2701 in FIG. 27) of this sub-embodiment, N_1=3, S_1={0, 1, 2}, N_2=2, S_2={4, 7}, N_3=4, S_3={3, 5, 6, 8}.

For a second example (e.g., 2702 in FIG. 27) of this sub-embodiment, N_1=3, S_1 {0, 1, 2}, N_2=2, S_2={5, 6}, N_3=4, S_3={3, 4, 7, 8}.

For a third example (e.g., 2703 in FIG. 27) of this sub-embodiment, N_1=3, S_1={1, 2, 3}, N_2=2, S_2={5, 7}, N_3=4, S_3={0, 4, 6, 8}.

For a fourth example (e.g., 2704 in FIG. 27) of this sub-embodiment, N_1=3, S_1={1, 2, 3}, N_2=2, S_2={4, 6}, N_3=4, S_3={0, 5, 7, 8}.

For a fifth example (e.g., 2705 in FIG. 27) of this sub-embodiment, N_1=3, S_1={1, 2, 3}, N_2=2, S_2={4, 7}, N_3=4, S_3={3, 5, 6, 8}.

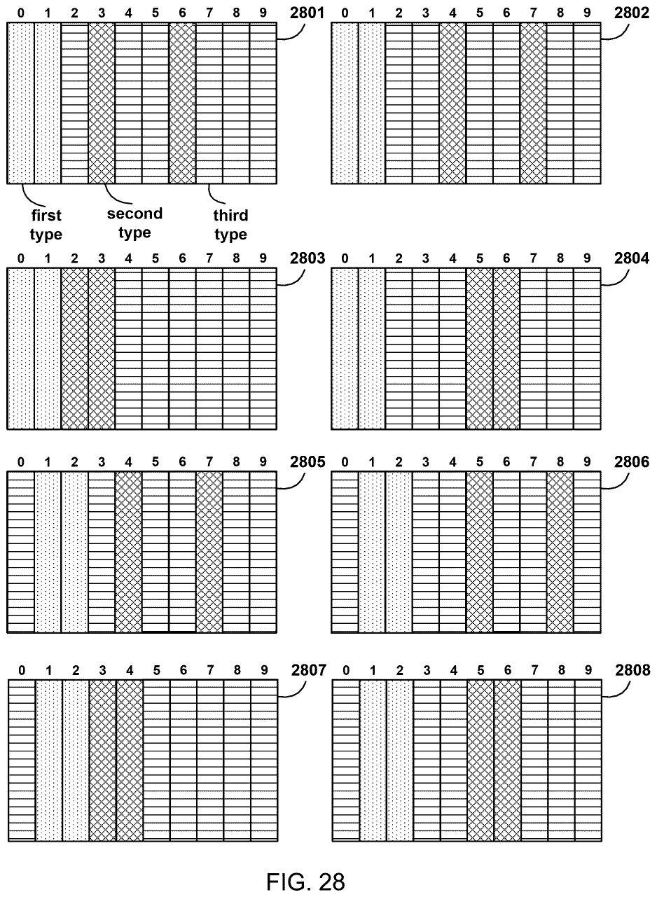

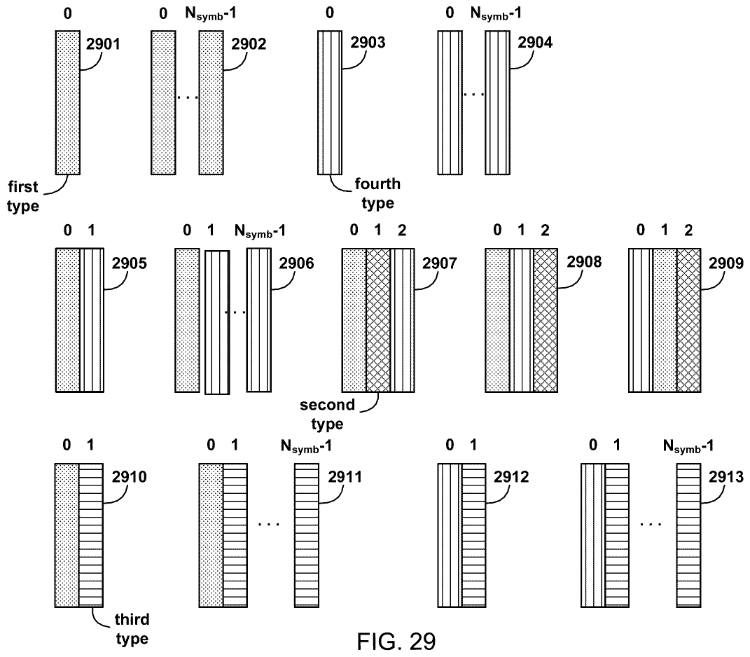

FIG. 28 illustrates examples of SSB structures according to embodiments of the present disclosure. More particularly, FIG. 28 illustrates SSB structures with 10 symbols. For example, these SSB structures can be implemented by BS 102 of FIG. 1. These examples are for illustration only and other embodiments can be used without departing from the scope of the present disclosure.

In one sub-embodiment, N_symb=10, e.g., N_1=2, N_2=2, and N_3=6.

For a first example (e.g., 2801 in FIG. 28) of this sub-embodiment, N_1=2, S_1={0, 1}, N_2=2, S_2={3, 6}, N_3=6, S_3={2, 4, 5, 7, 8, 9}.

For a second example (e.g., 2802 in FIG. 28) of this sub-embodiment, N_1=2, S_1 {0, 1}, N_2=2, S_2={4, 7}, N_3=6, S_3={2, 3, 5, 6, 8, 9}.

For a third example (e.g., 2803 in FIG. 28) of this sub-embodiment, N_1=2, S_1={0, 1}, N_2=2, S_2={2, 3}, N_3=6, S_3={4, 5, 6, 7, 8, 9}.

For a fourth example (e.g., 2804 in FIG. 28) of this sub-embodiment, N_1=2, S_1={0, 1}, N_2=2, S_2={5, 6}, N_3=6, S_3={2, 3, 4, 7, 8, 9}.

For a fifth example (e.g., 2805 in FIG. 28) of this sub-embodiment, N_1=2, S_1={1, 2}, N_2=2, S_2={4, 7}, N_3=6, S_3={0, 3, 5, 6, 8, 9}.

For a sixth example (e.g., 2806 in FIG. 28) of this sub-embodiment, N_1=2, S_1={1, 2}, N_2=2, S_2={5, 8}, N_3=6, S_3={0, 3, 4, 6, 7, 9}.

For a seventh example (e.g., 2807 in FIG. 28) of this sub-embodiment, N_1=2, S_1={1, 2}, N_2=2, S_2={3, 4}, N_3=6, S_3={0, 5, 6, 7, 8, 9}.

For an eighth example (e.g., 2808 in FIG. 28) of this sub-embodiment, N_1=2, S_1={1, 2}, N_2=2, S_2={5, 6}, N_3=6, S_3={0, 3, 4, 7, 8, 9}.

In one sub-embodiment, a SSB structure can be without OFDM symbol mapped for SSS, or PSS, or PBCH.

For one example, OFDM symbol(s) including SSS in the example SSB structures of this disclosure can be absent (e.g., the remaining OFDM symbols are shifted and re-indexed to consecutive OFDM symbols in the time domain).

For another example, OFDM symbol(s) including PSS in the example SSB structures of this disclosure can be absent (e.g., the remaining OFDM symbols are shifted and re-indexed to consecutive OFDM symbols in the time domain).

For yet another example, OFDM symbol(s) including PBCH in the example SSB structures of this disclosure can be absent (e.g., the remaining OFDM symbols are shifted and re-indexed to consecutive OFDM symbols in the time domain).

For one example, within the N_symb OFDM symbols of the SSB, N_4 number of the OFDM symbols are mapped for a fourth type of signal(s)/channel(s), and the set of indexes of the N_4 number of the OFDM symbols can be denoted as S_4.
For one sub-example, OFDM symbol(s) mapped for the first type of signal(s)/channel(s) in the example SSB structures of this disclosure can be replaced to be mapped for the fourth type of signal(s)/channel(s).
For another sub-example, OFDM symbol(s) mapped for the second type of signal(s)/channel(s) in the example SSB structures of this disclosure can be replaced to be mapped for the fourth type of signal(s)/channel(s).
For yet another sub-example, OFDM symbol(s) mapped for the third type of signal(s)/channel(s) in the example SSB structures of this disclosure can be replaced to be mapped for the fourth type of signal(s)/channel(s).

For one example, the OFDM symbol for the fourth type of signal(s)/channel(s) can at least include a tertiary synchronization signal (TSS).
For one sub-example, the bandwidth of the OFDM symbol can be N_RB RBs (e.g., 12·N_RB subcarriers), and a sequence for TSS is mapped to the center 127 subcarriers within the 12·N_RB subcarriers (e.g., mapped to subcarrier #(12·N_RB−127−1)/2 to #(12·N_RB+127−3)/2), with the remaining subcarriers as empty.
For another sub-example, the bandwidth of the OFDM symbol can be N_RB RBs (e.g., 12·N_RB subcarriers), and a sequence for TSS is mapped to the center 127 subcarriers within the center 12 RBs within the N_RB RBs (e.g., mapped to subcarrier #(12·N_RB−127−1)/2 to #(12·N_RB+127−3)/2), with the remaining RBs mapped for PBCH.
For yet another sub-example, the bandwidth of the OFDM symbol can be N_RB RBs (e.g., 12·N_RB subcarriers), and a sequence for TSS is mapped to all subcarriers within the N_RB RBs (e.g., truncation can be performed when the sequence after modulation (e.g., BPSK) is longer than all subcarriers within the N_RB RBs).
For yet another sub-example, the TSS can carry information of the physical cell ID.
For yet another sub-example, the TSS can carry information of an index of the SSB, such as a time domain index or part of the time domain index (e.g., LSB(s) of the time domain index) of the SSB, and/or a frequency domain index or part of the frequency domain index (e.g., LSB(s) of the frequency domain index) of the SSB.
For yet another sub-example, the TSS can carry information of a half frame index (e.g., to indicate which half frame in a frame that the associated SSB is located).
For yet another sub-example, the TSS can carry information of a system frame number (SFN) or part of the SFN (e.g., 1 or 2 or 3 or 4 LSB(s) of the SFN).
For yet another sub-example, the information is carried by cyclic shift(s) of sequence(s) generating the TSS.
For yet another sub-example, the information is carried by initial condition(s) of sequence(s) generating the TSS.
For yet another sub-example, the sequence for TSS can be common for DM-RS of PBCH, and the TSS can also be referred to as DM-RS of PBCH.

FIG. 29 illustrates examples of SSB structures according to embodiments of the present disclosure. More particularly, FIG. 29 illustrates SSB structures without PSS/SSS/PBCH. For example, these SSB structures can be implemented by BS 102 of FIG. 1. These examples are for illustration only and other embodiments can be used without departing from the scope of the present disclosure.

For a first example (e.g., 2901 in FIG. 29) of this sub-embodiment, N_symb=1, N_1=1, S_1={0}.

For a second example (e.g., 2902 in FIG. 29) of this sub-embodiment, N_symb=2 or 3 or 4 or 5 or 6, N_1=N_symb, S_1={0, . . . , N_symb−1}.

For a third example (e.g., 2903 in FIG. 29) of this sub-embodiment, N_symb=1, N_4=1, S_4={0}.

For a fourth example (e.g., 2904 in FIG. 29) of this sub-embodiment, N_symb=2 or 3 or 4 or 5 or 6, N_4=N_symb, S_4={0, . . . , N_symb−1}.

For a fifth example (e.g., 2905 in FIG. 29) of this sub-embodiment, N_symb=2, N_1=1, S_1={0}, N_4=1, S_4={1}.

For a sixth example (e.g., 2906 in FIG. 29) of this sub-embodiment, N_symb=3 or 4 or 5 or 6, N_1=1, S_1={0}, N_4=N_symb−1, S_4={1, . . . , N_symb−1}.

For a seventh example (e.g., 2907 in FIG. 29) of this sub-embodiment, N_symb=3, N_1=1, S_1={0}, N_2=1, S_2={1}, N_4=1, S_4={2}.

For an eighth example (e.g., 2908 in FIG. 29) of this sub-embodiment, N_symb=3, N_1=1, S_1={0}, N_2=1, S_2={2}, N_4=1, S_4={1}.

For a ninth example (e.g., 2909 in FIG. 29) of this sub-embodiment, N_symb=3, N_1=1, S_1={1}, N_2=1, S_2={2}, N_4=1, S_4={0}.

For a tenth example (e.g., 2910 in FIG. 29) of this sub-embodiment, N_symb=2, N_1=1, S_1={0}, N_3=1, S_3={1}.

For an eleventh example (e.g., 2911 in FIG. 29) of this sub-embodiment, N_symb=3 or 4 or 5 or 6, N_1=1, S_1={0}, N_3=N_symb−1, S_3={1, . . . , N_symb−1}.

For a twelfth example (e.g., 2912 in FIG. 29) of this sub-embodiment, N_symb=2, N_4=1, S_4={0}, N_3=1, S_3={1}.

For a thirteenth example (e.g., 2913 in FIG. 29) of this sub-embodiment, N_symb=3 or 4 or 5 or 6, N_4=1, S_4={0}, N_3=N_symb−1, S_3={1, . . . , N_symb−1}.

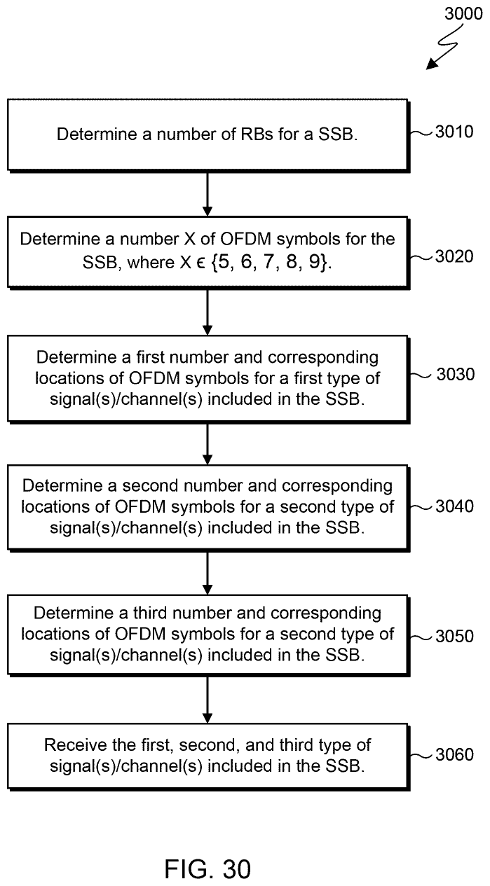

FIG. 30 illustrates an example method 3000 performed by a UE in a wireless communication system according to embodiments of the present disclosure. The method 3000 of FIG. 30 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3000 is for illustration only and other embodiments can be used without departing from the scope of the present disclosure.

In various embodiments, the method 3000 relates to receiving signal/channel in SSB based on SSB structure. The method 3000 begins with a UE determining a number of RBs for an SSB (3010). The UE then determines a number X of OFDM symbols for the SSB (3020). In various embodiments, X∈{5, 6, 7, 8, 9}. The UE then determines a first number and corresponding locations of OFDM symbols for a first type of signal(s)/channel(s) included in the SSB (3030). The UE then determines a second number and corresponding locations of OFDM symbols for a second type of signal(s)/channel(s) included in the SSB (3040). The UE then determines a third number and corresponding locations of OFDM symbols for a third type of signal(s)/channel(s) included in the SSB (3050). The UE then receives the first, second, and third type of signal(s)/channel(s) included in the SSB.

Although FIG. 30 illustrates one example method 3000 of the actions taken by the UE to receive signal/channel in SSB, various changes may be made to FIG. 30. For example, while shown as a series of steps, various steps in FIG. 30 could overlap, occur in parallel, occur in a different order, or occur any number of times.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a processor configured to determine multiple structures for a synchronization signals and physical broadcast channel (SS/PBCH) block, wherein a first structure and a second structure from the multiple structures differ in at least one of:
components included in the first structure and the second structure, and
multiplexing patterns of the components in the first structure and the second structure; and
a transceiver operably coupled to the processor, the transceiver configured to receive the SS/PBCH block based on the first structure or the second structure.

2. The UE of claim 1, wherein:
the processor is further configured to determine a common sub-block for the multiple structures, and
the common sub-block includes a primary synchronization signal (PSS), a secondary synchronization signal (SSS), and a physical broadcast channel (PBCH).

3. The UE of claim 2, wherein the common sub-block includes 12 resource blocks (RBs) in a frequency domain and 4 orthogonal frequency division multiplexing (OFDM) symbols in a time domain.

4. The UE of claim 3, wherein:
the PSS is mapped to a first OFDM symbol within the 4 OFDM symbols,
the SSS is mapped to a third OFDM symbol within the 4 OFDM symbols, and
the PBCH is mapped to a second and a fourth OFDM symbol within the 4 OFDM symbols.

5. The UE of claim 1, wherein the processor is further configured to:
identify a sequence for a primary synchronization signal (PSS) included in the received SS/PBCH block; and
determine, based on the sequence, a structure for the received SS/PBCH block from the multiple structures.

6. The UE of claim 1, wherein the processor is further configured to:
identify a sequence for a secondary synchronization signal (SSS) included in the received SS/PBCH block; and
determine, based on the sequence, a structure for the received SS/PBCH block from the multiple structures.

7. The UE of claim 1, wherein:
the first structure includes a physical broadcast channel (PBCH), and
the second structure does not include the PBCH.

8. A method of a user equipment (UE) in a wireless communication system, the method comprising:
determining multiple structures for a synchronization signals and physical broadcast channel (SS/PBCH) block, wherein a first structure and a second structure from the multiple structures differ in at least one of:
components included in the first structure and the second structure, and
multiplexing patterns of the components in the first structure and the second structure; and
receiving the SS/PBCH block based on the first structure or the second structure.

9. The method of claim 8, further comprising:
determining a common sub-block for the multiple structures,
wherein the common sub-block includes a primary synchronization signal (PSS), a secondary synchronization signal (SSS), and a physical broadcast channel (PBCH).

10. The method of claim 9, wherein the common sub-block includes 12 resource blocks (RBs) in a frequency domain and 4 orthogonal frequency division multiplexing (OFDM) symbols in a time domain.

11. The method of claim 10, wherein:
the PSS is mapped to a first OFDM symbol within the 4 OFDM symbols,
the SSS is mapped to a third OFDM symbol within the 4 OFDM symbols, and
the PBCH is mapped to a second and a fourth OFDM symbol within the 4 OFDM symbols.

12. The method of claim 8, further comprising:
identifying a sequence for a primary synchronization signal (PSS) included in the received SS/PBCH block; and
determining, based on the sequence, a structure for the received SS/PBCH block from the multiple structures.

13. The method of claim 8, further comprising:
identifying a sequence for a secondary synchronization signal (SSS) included in the received SS/PBCH block; and
determining, based on the sequence, a structure for the received SS/PBCH block from the multiple structures.

14. The method of claim 8, wherein:
the first structure includes a physical broadcast channel (PBCH), and
the second structure does not include the PBCH.

15. A base station (BS) in a wireless communication system, the BS comprising:
a processor configured to determine multiple structures for a synchronization signals and physical broadcast channel (SS/PBCH) block, wherein a first structure and a second structure from the multiple structures differ in at least one of:
components included in the first structure and the second structure, and
multiplexing patterns of the components in the first structure and the second structure; and
a transceiver operably coupled to the processor, the transceiver configured to transmit the SS/PBCH block based on the first structure or the second structure.

16. The BS of claim 15, wherein:
the processor is further configured to determine a common sub-block for the multiple structures, and
the common sub-block includes a primary synchronization signal (PSS), a secondary synchronization signal (SSS), and a physical broadcast channel (PBCH).

17. The BS of claim 16, wherein:
the common sub-block includes 12 resource blocks (RBs) in a frequency domain and 4 orthogonal frequency division multiplexing (OFDM) symbols in a time domain,
the PSS is mapped to a first OFDM symbol within the 4 OFDM symbols,
the SSS is mapped to a third OFDM symbol within the 4 OFDM symbols, and
the PBCH is mapped to a second and a fourth OFDM symbol within the 4 OFDM symbols.

18. The BS of claim 15, wherein the processor is further configured to:
determine a structure for the SS/PBCH block from the multiple structures; and
determine, based on the structure, a sequence for a primary synchronization signal (PSS) included in the SS/PBCH block.

19. The BS of claim 15, wherein the processor is further configured to:
determine a structure for the SS/PBCH block from the multiple structures; and
determine, based on the structure, a sequence for a secondary synchronization signal (SSS) included in the SS/PBCH block.

20. The BS of claim 15, wherein:
the first structure includes a physical broadcast channel (PBCH), and
the second structure does not include the PBCH.
